(19) United States
(12) Patent Application Publication
(10) Pub. No.: US 2026/0366623 A1
(43) Pub. Date: Nov. 19, 2026

(54) ROTARY COMPRESSOR, EXPANDER, AND PUMP WITH A SEALING SYSTEM

(71) Applicant: COOOL.ENERGY LTD, Kibbutz Erez (IL)

(72) Inventor: Michael ZETTNER, Omer (IL)

(21) Appl. No.: 19/132,506

(22) PCT Filed: Dec. 28, 2023
(86) PCT No.: PCT/IL2023/051332

§ 371 Date: May 23, 2025

(30) Foreign Application Priority Data
Dec. 29, 2022 (IL) 299605

(51) Int. Cl. F16J 15/3284; F04C 18/28; F16J 15/00

(52) U.S. Cl. CPC F16J 15/3284; F04C 18/28; F16J 15/004

(57) ABSTRACT

A sealing system for all those kind of rotary-mechanism, where two main rotating parts or systems are rotating relatively to each other around the same axis-one as rotor the other as stator- and form a radially and axially confined annular space between both main rotating parts, with at least one annular-chamber as part of the annular space, changing continuously the angular extension of the at least one annular chamber, and thus size in circumferential direction, caused by the rotation of the main rotating parts or systems and at the same time by the angular movement of at least one stationary part or stationary system fixed on one of the two main rotating parts or systems and the additional rotation of at least one additional rotating part or system, with a different centre-line, than the two main rotating parts or systems, embedded in the other main rotating part or system, thus combined, confining the annular space in both circumferential directions and thus forming an annular chamber with changing volume that is also confined in both circumferential directions. Each interrupted, and thus incomplete sealing-system of the rotating parts and systems of the rotary-mechanism, has at least one additional independent, uninterrupted, and thus complete sealing-system, following the interrupted sealing-system and being in fluid communication with the interrupted sealing-system, each such additional independent, uninterrupted, and thus complete sealing-system with several specific optional additional features, thus preventing or at least significantly minimising sealing losses of such a mechanical system.

### FIELD OF THE INVENTION

The invention is generally from the field of compressors, pumps, expanders, and engines. More specifically, the invention is from the field of rotating displacement-mechanism, like positive displacement compressors, -pumps, -expanders, and -positive-replacement engines, where two main parts or systems—the term ‘system’ is hereinafter used, if functional parts are actually several parts put together as one functional unit—are rotating relative to each other, with both relatively rotating parts or systems having the same, identical axis of rotation and with both relatively rotating parts or systems forming an annular space and with it an angular chamber that increases and decreases in its angular extension as a result of the relative rotation of both rotating parts or systems and other moveable- and stationary parts or systems.

### BACKGROUND OF THE INVENTION

For the purpose of compressing or expanding volumes, rotating mechanism are known and used. In FIG. 1 such an exemplary prior art mechanism is shown with a complete cut through the mid plane of that rotary-mechanism, perpendicular to the axis (referred herein as “centre-line”) of the rotors (represented in this and other Figs. as dashed line), revealing the rotor's interior, plus an additional partial cut only through the stator-shown with hatching-revealing also the cross-section of this exemplary rotary-mechanism.

In such rotatory-mechanism two main rotating parts or systems are rotating relatively to each other around the same centre—line-one as stator (1) the other as rotor (2), turning clock-wise in this example, and form a confined annular space between both main rotating parts or systems, whereby the size of this confined angular space is forming annular chambers (7), which are increasing and decreasing in circumferential extent (around the middle centre line), caused by the relative rotation of the main rotating parts or systems and at the same time by the angular movement of at least one stationary feature or part (5) on one of the two main rotating parts or systems-in this exemplary embodiment of FIG. 1—fixed on the rotor (2) and rotating therewith, and the projection of at least one additional moving part or system (6) reciprocating in and out of the annular space thus and forming with a stationary part (5) said annular chamber (7) that is thus also confined in both circumferential directions. (FIG. 1 shows an exemplary embodiment with three stationary parts (5) on the rotor (2), of the four moving parts or systems (6) the three visible moving parts or systems forming five annular chambers (7) of which only three are visible, with the moving part or system (6) on the right top side of FIG. 1 moving out of the annular chamber (7).)

Such rotary-mechanisms face difficulties in adequately sealing the annular space in circumferential direction—compared for example with the possible sealing of a piston in a cylinder. When the temperature of such a rotary-mechanism is changing—due to expansion or compression of gases, the total thermal-expansion (the increase of dimensions in millimetres) of the parts used in such a rotary-mechanism is axially and radially different.

The inner and outer radius of the annular space and thus of the annular-chamber are determining the length of the annular chamber—comparable with the length of a piston-stroke in a piston-compressor. The height of the annular-chamber—the distance from the inner radial boundary to the outer radial boundary—determines the possible volume at the end of a compression stroke and thus determines the possible compression-ratio or expansion-ratio. This is similar to the remaining space between the top of the cylinder and the top of the piston at the top-dead-centre of a piston-compressor.

The width of the annular space and thus of the annular chamber determines the ratio of outer surfaces of the annular-chamber to the volume of the compression- or expansion-chamber, which is the full usable length of the annular-chamber—what equals the volume-to-surface-ratio. With increasing width of the annular-chamber the volume-to-surface-ratio gets smaller and the heat-losses of the rotary-mechanism increase, as there is more surface per volume.

Thus, at the end there is no way to use the ratio of axial to radial length of the expansion chamber to compensate different heat-expansion due to different axial and radial lengths of the parts in such a rotary-mechanism to compensate the difference in total axial and radial expansion. This is shown in FIGS. 1A, 1B, and 1C were the different expansions—of such a system, as shown in FIG. 1—as an example made from the aluminium alloy Al6061 is displayed with the changing dimensions over different temperatures. The gaps between the rotating systems will thus consequently expand differently and thus it is close to impossible to seal the gaps especially at corners, when the radial and axial expansions are different.

U.S. Pat. No. 4,890,990—Zettner (WO1987002096A1) describes these difficulties of sealing the annular chamber of such a mechanism in circumferential direction, giving seven examples of such kind of mechanisms, with a projected feature or part (6) that is reciprocating in and out of the annular space.

U.S. Pat. No. 4,890,990—Zettner (WO1987002096A1) teaches a solution to this sealing problem in form of a paraboloid-of-rotation-like shaped cross-section of the annular space between the two rotating parts or systems and the necessary additional part or system which is projected in and out of the annular space, thus confining the annular space circumferentially, forming an annular-chamber.

FIG. 2 shows such a rotating mechanism with four visible annular chambers (7), which are confined in circumferential directions on one side by a stationary part or system (5)—three are visible—and at the other side by a projected part or system (6) fitted with the paraboloid-of-rotation-like cross-section of the annular space between the two rotating parts, according to U.S. Pat. No. 4,890,990—Zettner (WO1987002096A1). In FIG. 2 this mechanism is shown with a complete cut going through the mid-plane, perpendicular to the axis of the rotor (2) and an additional partial cut, only through the stator (2), parallel to the centre-line—with hatching—revealing the cross-section of such a paraboloid-of-rotation-like geometry, the paraboloid-of-rotation-like form enfolding the annular space between the two main rotating parts or systems (1 and 2) and thus forming and defining the boundaries between the inner rotor-part (2) and the outer stator-part (1) with two black arrows pointing to the paraboloid-of-rotation forms at two locations in FIG. 2.

The difference of the radial to axial expansion of the parts over heat is balanced and compensated by the angle of the side walls, which have the same or similar ratio, as the axial to radial ratio of the complete (e.g. compressor-, expander-, pump-, or engine-) system, thus lead to an even gap between the two main rotating parts or systems during and in event of changes of temperature, as it is explained in U.S. Pat. No. 4,890,990—Zettner (WO1987002096A1) from 1985.

If instead of a projected part or system (6), a rotating part or system, rotating around a separate, different centre-line, than the main rotating parts, is used, then the same difficulties to adequately seal the annular chamber in circumferential direction—compared for example to the possible sealing of a piston in a cylinder—remain.

In FIG. 3 only one half of such a rotating mechanism is shown in this prior art example, with a cut through the mid-plane, perpendicular to the main centre-line, revealing the mechanism. This mechanism as shown in FIG. 3 has the rotor (2) inside, rotating counter-clock-wise, has three annular chambers (7), which are confined in one circumferential direction by four fixed parts or features (5) integrated in the rotor (2) and in the other circumferential direction by three additional rotating parts or systems (3), rotating around a separate, different centre-line, than the two main rotating parts or systems.

In cases, where there are additionally to the two main rotating parts or systems one or more additional rotating parts, all with different centre-lines, than the two main rotating parts or systems, these additional rotating parts are generally referred to as ‘female-rotor’ and the part of the two main rotating parts, which is used as the rotating part (2) is referred to as ‘male-rotor’. In this description the same two terms will be used. FIG. 3 also shows inlets (11) and outlets (12).

U.S. Pat. No. 299,824A—James H. McVay—patented in the year 1884—shows an early example of such a mechanism with two female-rotors and three stationary features mounted on the male-rotor. U.S. Pat. No. 9,638,035B2—Zettner from the year 2010—shows a newer example of such a mechanism with six female-rotors (three are visible in the Figures) and seven stationary features mounted on the ‘male-rotor’.

When or if, using the form of a paraboloid-of-rotation-like cross-section of the annular space between the two main rotating parts—as U.S. Pat. No. 4,890,990 Zettner (WO1987002096A1) teaches—with female-rotors (3)—instead of projected parts (6)—then the desired sealing effect cannot be reached.

The female-rotor (3) needs to fit into the annular chamber in a way that the annular chamber is relatively seal, thus closest possible to be blocked in circumferential direction. In such kind of rotating mechanism, the volume of the annular-chamber (7) is confined between the female-rotor (3) and the stationary feature (6), as FIG. 3 shows this. This confined volume is changing, increasing or decreasing, by the relative rotation of the male rotor (2), as it is the case in the same way with the projected part (6), as shown in FIG. 2.

If the annual-chamber has a specific paraboloid-of-rotation-like cross-section, also the female-rotor (3) needs to have an inverted fitting form, thus also an inverted paraboloid-of-rotation-like cross-section.

FIG. 4 shows a cut through the mid-plane, perpendicular to the main centre-line with an additional partial cut through such a mechanism in the plane defined by both centre-lines—the centre-line of the two main rotating parts or systems of the mechanism and the centre-line of the female-rotor (3), which can be seen in FIG. 4 on the top. Along this plane of the shown cut, the annular-space, thus the annular chambers (7), and the female-rotor (3) are congruent or close to congruent, thus fitting, with some necessary minimal space or clearance between the three different parts or systems, consequently allowing all three parts or systems—in the example of FIG. 4 the male-rotor (2), the female-rotor (3) and the stator (1)—to rotate freely relatively to each other.

Only in this plane-defined by the centre-lines of the male-rotor (2) and the female-rotor (3)—as shown again in FIG. 5, however without the cut through the mid-plane, perpendicular to the main centre-line, the three different systems align in the same way as described in U.S. Pat. No. 4,890,990—Zettner (WO1987002096A1) in FIGS. 3 and 4 of that patent.

As shown in FIG. 4 each female-rotor (3) has a round or rotationally-symmetric outer surface with at least one recess (13) through which the stationary feature or part (5) can pass when the male-rotor (2) is turning.

FIG. 4A shows one complete female rotor (3) without any cuts, thus revealing clearly the rounded form of the female rotor (3) beside a cut female rotor in FIG. 4.

The rotationally-symmetric outer surface of each female-rotor (3) fits inside the form-fitting recess of the main rotating part, in which the female rotor (3) is embedded, the way shown in FIGS. 4 to 7, where the female-rotor (3) is embedded in the stator (1).

The curvature of this round outer surface of the female-rotor (3), when continuing circumferentially around the centre-line of the female-rotor (3) after being at the point, closest to the outer circumference of the inner of the two main rotating parts, what is shown in FIG. 4, is different, than the rounded form of the part, of the main rotating parts or systems, in which the female-rotor (3) is embedded, which is continuing around the centre-line of the two main rotating parts or systems.

It is this difference between these two curvatures, which leads to a very sharp angle between the two round parts, the female-rotor (3) and the main rotating part, in which the female rotor (3) is embedded.

FIG. 6 shows exactly the same as FIG. 5 plus an additional section through a plane that is perpendicular to the plane between both rotating centre-lines of FIG. 5. Thus FIG. 6 reveals, easily recognisable, this very sharp angle (14), which is the result of the different curvatures of the form-fitting recess for the female-rotor (3) and the part of the main-rotating-parts or systems, in which the female-rotor (3) is embedded.

The form-fitting recess in the main-rotating-part or system (1), in which the female-rotor (3) is embedded, needs to follow the form of the female-rotor (3) in order to form a congruent or similar form-fitting recess—otherwise the female-rotor (3) would not be able to form together with the main-rotating part or system (1), in which the female rotor (3) is embedded, a closed and a fairly seal system thus forming one closed structure, which is confining the annular chamber (7) of the compressor-, expander-, or pump-mechanism in circumferential direction. If this were not the case and both parts or systems—the female rotor (3) and the part of the main-rotating-part or system (1), in which the female-rotor (3) is embedded—were only loosely together the basic function of the compressor, expander, or pump would not be possible, as relative pressure or built-up of pressure in a chamber that is not confined and thus not relatively sealed to the surrounding, can physically not be achieved.

Because the cross-sections of both forms—the form of the female-rotor (3) and the form of the main-rotating part or system (1), in which the female rotor (3) is embedded—are annular versions of the same basic hyperboloid geometry of their respective cross-section, however with different centre-lines and different diameters, this sharp edge (14) is unavoidable.

This sharp edge (14), already shown in FIG. 6, is shown as enlargement in FIG. 7 thus this sharp edge (14) between the stator (1), male-rotor (2) and the female-rotor (3) is easier to see.

In FIG. 8 exactly the same is shown, as in FIG. 7, however without the male-rotor. This allows a better view of said sharp edge (14) and its round shape.

Such a sharp edge (14) as shown in FIG. 6, FIG. 7, and FIG. 8 can in reality not be produced, and always requires a minimum radius.

FIG. 9 shows the same enlargement as FIG. 7, however in this example with a small radius (15) of just half a millimetre (—this is smaller, than 0.02 inch) at this sharp edge (14), while the diameter of the saddle-point (16) of the shown paraboloid-of-rotation-like cross-section of the mechanism shown as a possible example in FIGS. 5 to 7 has a diameter of about 200 millimetres.

This small radius (15)—as shown in FIG. 9—at this sharp edge (14) leads to a significantly wide gap between the different rotating parts or systems. Thus, this significantly wide gap leads to leakage losses, where the used medium will just escape and will thus not allow to hold or built-up pressure in the annular-chamber. Even if a lubricant were used to increase the sealing effects of such a mechanism, it would not be sufficient to bridge such a significantly wide gap.

This significantly wide gap, caused by the necessary described radius (15) at the described edge (14), is a hollow form with also an annular form, which follows the form of the female-rotor (3), as can be seen in FIG. 8.

Through this significantly wide gap, an annular, hollow space between the female-rotor (3) and the main rotating part, in which the female rotor (3) is embedded (1), gases or liquids can leave unhindered the annular chamber. Due to this occurring significantly wide gap at the described edge (14), it is either impossible to seal the confined annular chamber of such a rotary-mechanism, by using the form of a paraboloid-of-rotation-like cross-section of the confined annular space between the two main rotating parts—as U.S. Pat. No. 4,890,990 Zettner (WO1987002096A1) teaches—or significant leakages losses are the consequence.

Consequently built-up of pressure, relative to the surrounding, cannot be kept in the confined annular chamber of such a rotary-mechanism, as this confined annular chamber is open at the significantly large gap, which occurs twice in confined annular space—on both sides of the mid-plane of each confined annular chamber of such a rotary-mechanism.

As this annular sharp edge cannot be avoided, as it is an indirect result of the bending form of the sides of such geometrical forms, this significantly wide gap as a direct result of this sharp edge, can also not be avoided in such geometry.

In the prior art examples, above the version, where the paraboloid-of-rotation-like shape is bent with the arms of the paraboloid-like shape outwards, away from the centre-line of the main rotating parts and with the saddle point in the middle inwards, is described in U.S. Pat. No. 4,890,990 Zettner (WO1987002096A1) as the ‘concave’ form of the rotary-mechanism.

In the form, where the arms of the paraboloid shape are bent towards the centre-line of the main rotating parts and the saddle point is bent outwards, what is described in U.S. Pat. No. 4,890,990 Zettner (WO1987002096A1) as the ‘convex’ form, the same basic geometrical problem of the described hollow space occurs.

What this analysis above clearly shows is that the occurring problems of using the suggested shape of a paraboloid-of-rotation-like cross-section of the annular space between the two main rotating parts or systems—as U.S. Pat. No. 4,890,990 Zettner (WO1987002096A1) teaches—with female-rotors (3) instead of projected parts—are based on fundamental, complex, three-dimensional geometry and cannot be solved, by adding here or there an additional radius.

A very similar problem based on this kind of complex three-dimensional geometry of rotating annular bodies is also preventing the use of rounded forms of the circumferential edges in vane-compressors, where the rotor and stator are also positioned on two different centre-lines. For more than 150 years experts and inventors are looking—unsuccessfully—for a solution to this specific problem of complex three- to four-dimensional (movement) geometries.

Additionally to the problem described above, the female-rotor (3) needs in such a mechanism, as described above and shown in the FIGS. 4 to 9, a minimum clearance between the female-rotor (3) and the main rotating part or system, in which the female rotor (3) is embedded (1), allowing free rotation. This minimum gap needs also to be considered and either additionally sealed or additional leakage losses will lower the efficiency of such a mechanism. In FIG. 2 the mechanism according to U.S. Pat. No. 4,890,990 Zettner (WO1987002096A1) with two main rotating systems—outside the stator (1), inside the rotor (2)—with three visible stationary features or parts (5) on the rotor (2) and three visible moving parts (6), which close the annular chambers (7) when projected into the annular space between the two main rotating parts or systems shows a slightly conical shape of the moving parts (6), so when they are closed the moving parts can also seal the connection with the stator (1) where they are embedded. The problem of the necessary minimum clearance does here—for such a system with only two main rotating parts or systems and no female rotors but instead projected features—not occur.

### General Description

The invention offers a sealing system for all those kind of rotary-mechanism, where two main rotating parts or systems are rotating relatively to each other around the same axis—one as rotor the other as stator—and form a radially and axially confined annular space between both main rotating parts, with at least one annular-chamber as part of the annular space, changing continuously the angular extension of the at least one annular chamber, and thus size in circumferential direction, caused by the rotation of the main rotating parts or systems and at the same time by the angular movement of at least one stationary part or stationary system fixed on one of the two main rotating parts or systems and the additional rotation of at least one additional rotating part or system, with a different centre-line, than the two main rotating parts or systems, embedded in the other main rotating part or system, thus combined, confining the annular space in both circumferential directions and thus forming an annular chamber with changing volume that is also confined in both circumferential directions.

In such kind of rotary-mechanism, as defined above, there needs to be a minimum clearance between the different parts or systems, allowing these parts or systems to rotate relatively to each other, especially then, when these parts or systems are changing temperature and thus expand or contract.

Said minimum clearance between these rotating parts or systems leads to gaps, which in turn can and will lead to leakage-losses of the compressor-, expander, or pump-mechanism. Thus there is no possible way to have a sealing-system in such kind of rotary-mechanism, which is closed all around in circumferential direction.

There will always be an interruption of the geometrical form where the necessary form-fitting recess for female-rotor (3) is—this recess is clearly visible in FIG. 22.

Thus only interrupted sealing-systems are possible. Any seal that is not closed, but interrupted, has a limited sealing effect.

The basic idea of the invention is adding to and combine with each interrupted, thus incomplete sealing-system of the rotating parts and systems of the rotary-mechanism, at least one additional independent, uninterrupted, and thus complete sealing-system, following the interrupted sealing-system and being in fluid communication with the interrupted sealing-system, each such additional independent, uninterrupted, and thus complete sealing-system with several specific optional additional features, thus preventing or at least significantly minimising sealing losses of such a mechanical system. This is realised with a defined geometry, which also allows the use of the occurring centrifugal-forces of the medium in the rotary-mechanism—may this mechanism be used as a compressor, a pump, or an expander—and further contributing additional sealing effects.

### Possible Use of the Invention for Different Rotary-Mechanism Configurations

There are many ways, how such a rotating mechanism can be configured and realised. The invention can be used for all those possible configurations. For example with the inner of the two main rotating parts or systems—rotating relatively to each other around the same centre-line—functioning as the rotor and the outer of the two main rotating parts or systems functioning as the stator, with at least one recess for at least one additional rotating part or system with a different centre-line, than the two main rotating parts or systems as has been shown in FIG. 4.

As this is just an example, the configuration of the rotating parts or systems can also be configured in a way that the inner part of the two main rotating parts or systems is the stator, as it is also possible that the stationary feature is either on the stator or the rotor, either on the inner part or the outer part, as it is the case with the female-rotor (3) or female rotors (3), which can be either on the stator or the rotor, either embedded in the inner part of the two main rotating parts or embedded in the outer of the two main rotating parts.

While in the used examples the additional rotating parts or systems, embedded in one of the two main rotating part or system, are shown and described in the different examples and Figures with just one recess (13), passing over or through the projected feature on the other main rotating part, it is also possible to have more, than one such recess in an additional rotating part or system as shown in FIG. 30.

It is also possible to have several such rotary-mechanism connected in series—like multi-stepped piston-compressors—where the pressure is increased or decreased in steps, each step realised in a separate pressure-step, thus having more, than one single mechanism parallel to each other.

Following are some examples of embodiments of the invention:

Example 1. A sealing system for a rotary mechanism comprising:
two main rotating parts or systems configured to rotate around a first axis line common to said two main rotating parts or systems;
   at least one stationary part protruding out of one of said two main rotating parts or systems and into annular space enclosed by said two main rotating parts or systems, wherein said at least one stationary part creating at least one chamber in said annular space;
   and at least one additional rotating part or system accommodated in a form fitting recess within one of said two main rotating parts or systems, said additional rotating part or system is configured to rotate within said form fitting recess around a second axis;
   wherein inner boundary of outer of said two main rotating parts or systems complements outer boundary of inner of said two main rotating parts or systems, wherein said at least one additional rotating part or system interrupts an otherwise circular uninterrupted gap between said inner and outer boundaries of said two main rotating parts or systems into interrupted gaps between said inner and outer boundaries and between said additional rotating part or system and said outer boundary,
   wherein fluid communication between said interrupted gaps is sealed and prevented by splitting said interrupted gaps between said main rotating parts or systems away from said gap between said additional rotating part or system and said main rotating part or system, where said additional rotating part or system is embedded, said splitting away backing-up leakage losses and enabling build-up of axial sealing between edges of said inner and outer boundaries of said two main rotating parts or systems and of said boundaries where said additional rotating part or system is embedded.

Example 2. The sealing system for a rotary mechanism according to example 1, wherein axial limits of said annular space formed between said two main rotating parts or systems are annular rims, said annular rims extend radially above boundary of said one of said two main rotating parts or systems, wherein said edges of second of said two main rotating parts or systems are recesses radially indented inwards relative said boundary of said second of said two main rotating parts or systems, wherein shape of said radially indented recesses complements shape of said annular rims.

Example 3. The sealing system for a rotary mechanism according to example 2, wherein said splitting away is done by bending surface of said gap between edges of said inner and outer boundaries towards said first axis of said two main rotating parts or systems, and bending surface of said gap between said additional rotating part or system and the part or system where it is embedded away from said first axis of said two main rotating parts or systems.

Example 4. The sealing system for a rotary mechanism according to example 3, wherein angle of bending of said surface of said gap between edges of said inner and outer boundaries is about 81°.

Example 5. The sealing system for a rotary mechanism according to example 2, wherein said rims and recesses have a rounded shape of their cross-section.

Example 6. The sealing system for a rotary mechanism according to example 1, wherein said at least one stationary part or system together with at least one said additional rotating part or system divides said annular space into at least two annular chambers with varying angular extensions, said annular chambers are configured to contain fluids either being compressed or expanding inside said annular space, and contract and expand said fluids inside said annular chambers upon rotation of said two main rotating parts relative each other.

Example 7. The sealing system for a rotary mechanism according to example 6, wherein each of said at least one additional rotating part or system comprises each at least one recess configured for coupling with said at least one stationary part upon rotation of said additional rotating part or system within said form fitting recess relative and simultaneously, thus synchronised, with said rotation of said two main rotating parts or systems relative each other, wherein said coupling allows each of said stationary part to pass through each of said at least one additional rotating parts.

Example 8. The sealing system for a rotary mechanism according to example 1, wherein space of said form fitting recess comprises marginal space additional to space occupied by said additional rotating part or system, said space is configured to enable free rotation of said additional rotating part or system.

Example 9. The sealing system for a rotary mechanism according to example 2, wherein said edges of said annular space enclosed by said two main rotating parts or systems increase radius of radial boundaries of said annular space with nearing axial edges of said annular space, wherein said increase of radius towards said edges increases relative rotational speed of sides of said chamber(s), wherein said increase of radius generates an axial force-vector in compressed, expanding or pumped fluids inside said annular chamber(s) towards said protruding annular rims, wherein said axial force vector causes droplets, mist, and/or heavier components to separate from lighter components and flow axially sideward towards said protruding annular rims, said droplets, mist and/or heavier components generate a film of droplets at the areas with largest radius.

Example 10. The sealing system for a rotary mechanism according to example 9, wherein said droplets, mist and or heavier components generate a film of droplets at radially outer edge of said protruding annular rims.

Example 11. The sealing system for a rotary mechanism according to example 2, wherein length of a specific path from a saddle-point of said annular rim with an outwards rounded cross-section, passes a splitting point, continues through at least one of continuations of split-away gap between said two main rotating parts or systems or around said at least one additional rotating part or system, wherein said path is configured to take fluids under a specific determined maximum pressure in said annular chamber(s), wherein travelling time of said fluids with a specific flow-speed is longer along said path, than relative travelling time of said fluids in said annular chamber(s), said annular chamber(s) rotating with a selected angular speed, wherein said angular speed of said annular chamber(s) is suitable for switching from a performance of a pressure-stroke with high pressure to a suction-stroke with low pressure, or from a performance of an expansion-stroke with high pressure to a complete expansion or a condensation-stroke in the annular chamber(s), wherein said switching reverses pressure difference between said path and said annular chamber(s), wherein reversing said pressure difference causes leaking and escaping fluids inside said gap, change their direction and flow backwards towards said annular chamber(s), wherein said change of direction and flow backwards prevents leaking and escaping of said fluids inside said gap out of said rotary mechanism.

Example 12. The sealing system for a rotary mechanism according to example 2, wherein angle, with which continuation of said gap is bent toward said axis of said two main rotating parts or systems reflects at least approximate relation of axial to radial dimension of said rotary mechanism, wherein occurring expansion of said rotary mechanism caused by changes of temperature lead to no change, or approximately no change of width of said gap, when specific axial to radial relation of contour of continuation of said gap is within ±25% of said axial to radial relation of said rotary mechanism.

Example 13. The sealing system for a rotary mechanism according to example 11, wherein at least one of split-away continuations of said gaps comprises at least one other protruding annular rim with an outwards rounded cross-section with a saddle-point, wherein said one other protruding annular rim is configured to accumulate and hold fluids by exerted centrifugal forces in said split-away continuation of said gaps, wherein said fluids and droplets and mist form a film at said saddle-point thus constituting a blocking sealing feature, said blocking sealing feature prevents leakage of fluids through said at least one split-away continuations of said gaps and backs-up leakages from said interrupted part of said gaps at said protruding annular rim with an outwards rounded cross-section through said split-away continuations of said gaps.

Example 14. The sealing system for a rotary mechanism according to example 13, wherein said at least one other protruding annular rim facilitates a pressure drop caused by an enlarged cross-section and gains an additional feature to said film at said saddle-point, thus constituting a double-acting blocking sealing feature, which is configured to prevent leakage of fluids through said at least one of said split-away continuations of said gaps and back-up leakages from said interrupted part of said gaps at said protruding annular rim with an outwards rounded cross-section through said split-away continuations of said gaps.

Example 15. The sealing system for a rotary mechanism according to example 11, wherein at least one of said split-away continuations of said gaps comprises a rotary-sealing at its end, said rotary-sealing constituting a blocking sealing feature, which prevents leakage of fluids through said at least one of said split-away continuations of said gaps and backs-up leakages from said interrupted part of said gap at said protruding annular rim with an outwards rounded cross section through said split-away continuations of said gaps, said rotary sealing is selected from a standard-rotary-sealing and or capsulated bearings.

Example 16. The sealing system for a rotary mechanism according to example 15, wherein said capsulated bearings are capsulated ball-bearings.

Example 17. The sealing system for a rotary mechanism according to example 11, wherein said at least one of the split-away continuations of said gaps changes dimension of width of said gap from increasing to decreasing said width, wherein said change of dimensions of said width effects pressure-drop and slowing of flow-speed of leaking fluids in said gap, wherein said pressure drop and slowing of flow-speed prevent at least a significant part of said leaking fluids from escaping through said gap, and leakage of fluids through said at least one of said split-away continuations of said gaps, wherein preventing said escaping and leakage backs-up leakages from said interrupted part of said gap at said protruding annular rim with an outwards rounded cross-section through said split-away continuations of said gaps, wherein number of times of change of dimensions of said width is between one and several times.

Example 18. The sealing system for a rotary mechanism according to example 11, wherein said at least one of said split-away continuations of said gaps comprises three-dimensional structural features at least on one part of surfaces facing said split-away continuation of said gaps, said three-dimensional structural features increasing friction and drag of said fluids in said gap, thus effecting pressure drop and slowing of flow-speed of leaking fluids in said gap, wherein a pressure drop of said leaking fluids reached within said gap prevents at least a significant part of said leaking fluids from escaping through said gap, preventing leakage of said fluids through said at least one of said split-away continuations of said gaps and backing-up leakages from said interrupted part of said gap at said protruding annular rim with an outwards rounded cross-section through said split-away continuations of said gaps.

Example 19. The sealing system for a rotary mechanism according to example 18, wherein said three-dimensional structural features at least on one part of surfaces facing said split-away continuation of said gaps is selected from cross-honing, indentations and protruding features.

Example 20. The sealing system for a rotary mechanism according to any one of the preceding examples, wherein said rotary-mechanism comprises at least two steps with similar forms and features, wherein said rotary mechanism is selected from a compressor and an expander.

Example 21. The sealing system for a rotary mechanism according to example 20, wherein said rotary mechanism is a compressor, wherein said compressor is configured to reach an increase of pressure in a first step of said at least two steps and a further increase of said pressure to a higher pressure in a second step of said at least two steps.

Example 22. The sealing system for a rotary mechanism according to example 20, wherein said rotary mechanism is an expander, wherein said expander is configured to reach a decrease of pressure in a first step of said at least two steps and a further decrease of said pressure to a lower pressure in a second step of said at least two steps.

Example 23. The sealing system for a rotary mechanism according to any one of the preceding examples, wherein said two main rotating parts or systems are a rotor and a stator.

Example 24. The sealing system for a rotary mechanism according to example 23, wherein said rotor is inner part or system of said two main rotating parts or systems and said stator is outer part or system of said two main parts or systems.

Example 25. The sealing system for a rotary mechanism according to example 23, wherein said stator is outer part or system of said two main rotating parts or systems and said rotor is inner part or system of said two main parts or systems.

Example 26. The sealing system for a rotary mechanism according to example 1, wherein said at least one additional rotary part or system is a female-rotor.

Example 27. The sealing system for a rotary mechanism according to example 1, wherein said at least one additional rotary part is a female-rotor, wherein said female rotor is embedded in outer rotary part or system of said two main rotary parts or systems.

Example 28. The sealing system for a rotary mechanism according to example 26, wherein said female-rotor is embedded in inner rotary part or system of said two main rotary parts or systems.

Example 29. The sealing system for a rotary mechanism according to any one of the preceding examples, wherein said rotary mechanism is inverted, wherein split-away continuations of gaps are bending outwards, away from said one axis of said two main rotary parts or systems and from said second axis of said at least one additional rotating part, said at least one additional rotating part is mounted on and integrated into inner of said two main rotating parts or systems, wherein sealing features of said sealing system are adjusted to said inverted rotary mechanism.

Any suitable combinations of these examples may operatives in these and other embodiments of the invention.

### BRIEF DESCRIPTION OF THE DRAWINGS

FIG. 1 illustrates a rotating mechanism for the purpose of compressing or expanding volumes.

FIGS. 1A, 1B, and 1C illustrate the differences of axial to radial expansion over temperature

FIG. 2 illustrates a rotating mechanism with four visible annular chambers.

FIG. 3 illustrates half of a rotating part or system, rotating around a separate, different centre-line, than the main rotating parts.

FIG. 4 illustrates a cut through the mid-plane, perpendicular to the main centre-line with an additional partial cut through such a mechanism in the plane defined by both centre-lines.

FIG. 4A illustrates a female rotor completely without the cut of FIG. 4 thus revealing the rounded shape of the female rotor.

FIG. 5 illustrates the mechanism of FIG. 4 without the cut through the mid-plane.

FIG. 6 illustrates exactly the same as FIG. 5 plus an additional section through a plane that is perpendicular to the plane between both rotating centre-lines of FIG. 5.

FIG. 7 illustrates an enlargement of the mechanism in FIG. 6.

FIG. 8 illustrates the same as in FIG. 7 without the male-rotor.

FIG. 9 illustrates the same enlargement as FIG. 7 but with a small radius.

FIG. 10 illustrates the main rotating parts or systems that define and partly confine an annular space between them.

FIG. 11 illustrates the annular chambers with different angular sizes.

FIG. 12 illustrates an enlarged partial section of the rotary mechanism through the centre-line.

FIG. 13 illustrates a partial cut on both axial sides of the annular space and thus the annular chamber.

FIG. 14 illustrates the form-fitting recess in the female rotor (3).

FIG. 15 illustrates the same as FIG. 14 from a different view-point, with a part of the inner part of the rotating parts or systems partly cut away.

FIG. 16 illustrates the same as FIG. 14, however from a different view-point, with a part of the inner part of the rotating parts or systems—in our exemplary embodiment the rotor (2)—partly cut away to allow a free view to where and how a female rotor (3) is embedded in the outer part—in our exemplary embodiment the stator (1).

FIG. 17 illustrates a partial cut where the female-rotor (3) and the main rotating part or system are interrupting the otherwise uninterrupted closed surface of the congruent, fitting negative counter form.

FIG. 18 illustrates two “damaged” different conventional rotary sealings.

FIG. 19 illustrates the formed pockets between two axial boundaries of the annular space with or through the protruding annular rim with an outwards rounded cross-section and the fixed features.

FIG. 20 illustrates how the necessary gap between the inner and outer rotating parts or systems continues beyond the protruding annular rim.

FIG. 21 illustrates a cut through the centre of a female-rotor (3) and additional features like additional saddle-points as part of the un-interrupted continuations of the gaps.

FIG. 22 illustrates the continuation of the gap between the main rotating parts or systems and a recess for a female-rotor.

FIG. 23 illustrates a visible complete female-rotor on the male-rotor with the stator cut along the centre-line of the female-rotor.

FIG. 24 illustrates travel of fluids.

FIG. 25 illustrates the saddle-points with enlarged cross-section and thus increased volumes.

FIG. 26 illustrates the leaking fluids that can be stopped from escaping the system with several succeeding saddle-points.

FIG. 27 illustrates the female rotors embedded in the inner of the two main rotating parts or systems with the gap between the two main rotating parts or systems bent outwards.

FIG. 28 illustrates a female rotor with openings in the paraboloid-of-rotation-like form in the secondary, uninterrupted sealing features, which is used as a rotary-slide-valve.

FIG. 29 illustrates a conventional rotary sealing at the end of the axial extension axially after the second, uninterrupted sealing feature.

FIG. 30 illustrates more than one form-fitting recess in a female-rotor.

### DETAILED DESCRIPTION OF THE DRAWINGS

The invention, a new sealing system for all kinds of rotary-mechanism as described above, is explained and laid-out in several steps.

In the first step, the geometrical forms and boundaries of the mechanism are explained followed, as the second step, by the explanation of the function of the two complementing sealing-sub-systems—the interrupted sealing-system and the un-interrupted sealing-system—followed, as the third step, by how these two sealing-sub-systems function together.

### The Annular Space and Annular Chamber and its Radial Boundaries

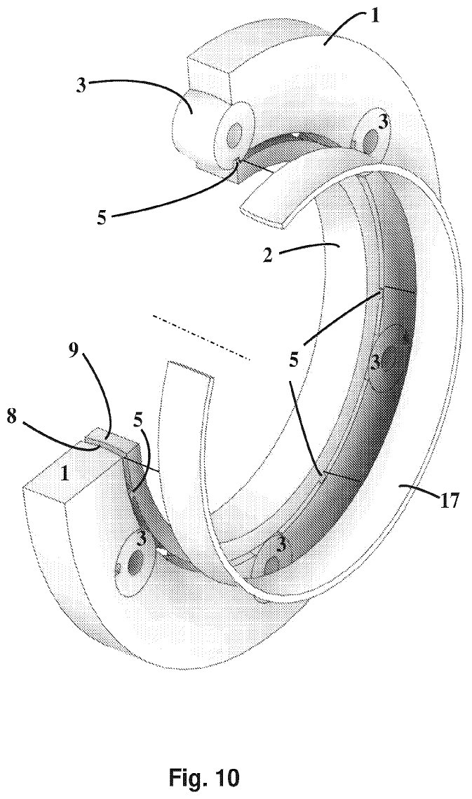

As shown in FIG. 10, both of the main rotating parts or systems define and partly confine an annular space between them. The outer radial boundary of the inner part (8)—in our exemplary embodiment the rotor (2)—and the inner radial boundary of the outer part (9)—in our exemplary embodiment the stator (1)—are the radial boundaries of the annular space (17). In FIG. 10 this annular space (17) is—for better understanding—projected beside the rotary-mechanism as a solid geometrical form—in reality it is a hollow space between the two rotating parts or systems, as described.

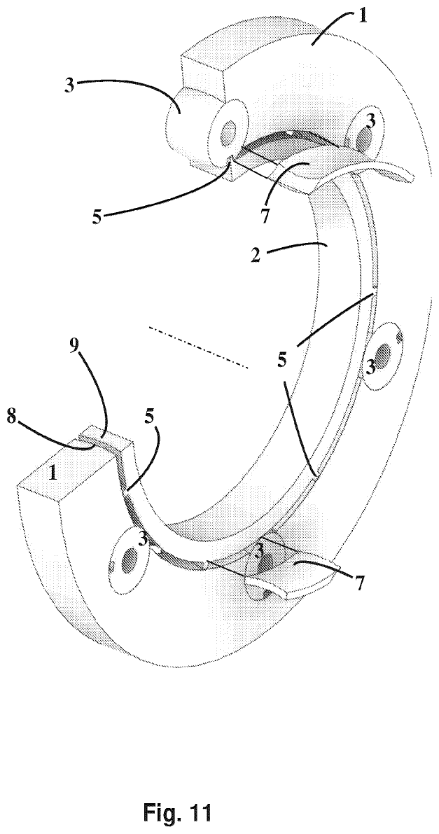

In FIG. 11 two annular chambers (7) with different angular sizes can be seen—in a similar projected way—as two separate geometrical figures directly beside and projected from the parts of the rotary-mechanism, the female-rotors (3) and the fixed feature or part (5) which are defining the annular chambers (7).

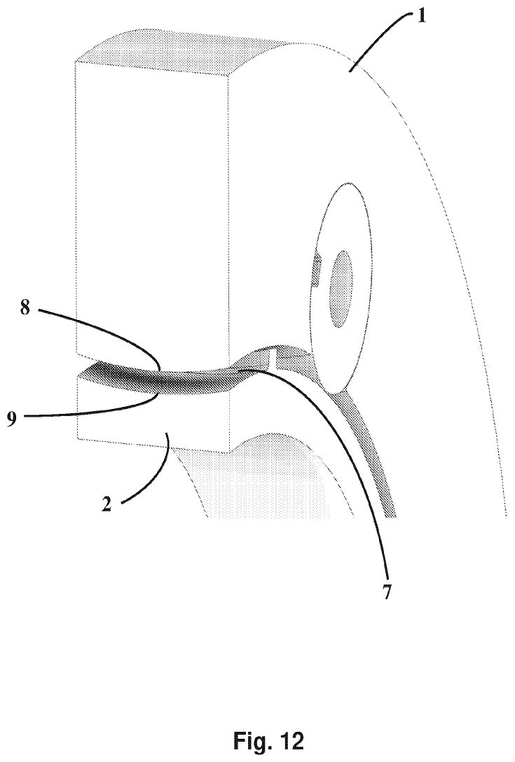

FIG. 12 shows an enlarged partial section of the rotary mechanism through the centre-line, with the cut at a position, where there is no form-fitting recess in the main rotating part or system, in which the female-rotor is embedded. Thus the radial boundaries of the annular space and the annular chamber (7) are clearly visible between the inner boundary (8) of the outer main rotating part and the outer boundary (9) of the inner main rotating part or system.

The exact shape of the radial boundaries of the annular chamber is for the function of the sealing-system not that important and the radial boundaries can be either straight or curved inward or outward, or any other chosen form.

In most cases the best form for both radial boundaries—inner boundary (9) and outer boundary (8)—would be slightly curved inwards towards the centre-line of the two main rotating parts or systems, as shown in FIG. 12, in order to use occurring centrifugal forces for additional supporting effects. These additional supporting effects, to further increase the sealing-function, are described with more details further below.

### The Axial Boundary of the Annular Chamber

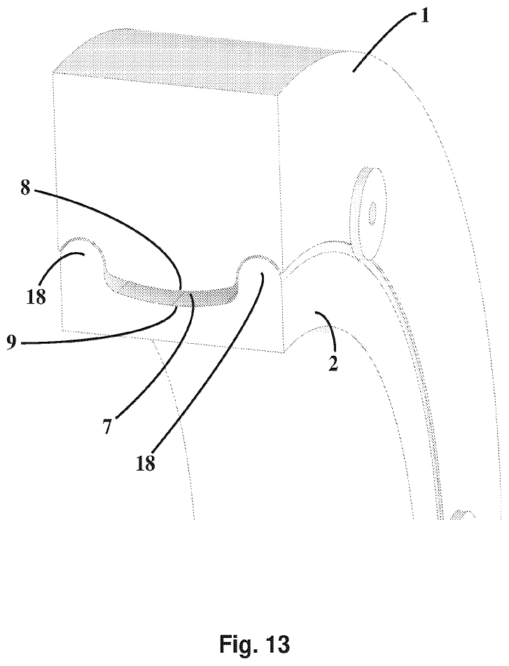

FIG. 13 shows—with a partial cut—on both axial sides of the annular space and thus the annular chamber (7) a protruding annular rim with an outwards rounded cross-section (18) as part of the inner of the main rotating parts—the rotor (2)—protruding radially farther outwards than the outer radial boundary of the annular space and thus radially farther outwards, than the annular chamber (7). This protruding annular rim with an outwards rounded cross-section (18) functions as the axial or lateral boundary of the annular space and thus the annular chamber (7). Together with a congruent, fitting negative counter-form on the other main rotating part or system—in this exemplary embodiment the stator (1)—the protruding annular rim with an outwards rounded cross-section (18) forms a gap, caused by the required clearance between the two main rotating parts or systems to allow them to rotate freely relatively to each other.

The Exact Form of the Protruding Annular Rim with an Outwards Rounded Cross-Section of the Axial Boundary

The protruding annular rim with an outwards rounded cross-section is defining and confining the annular space and thus the annular chamber axially or laterally. While in FIG. 13 this protruding annular rim with an outwards rounded cross-section is shown with a quite circular cross-section, for the sealing-function also similar shapes, elliptical shapes, any kind of polygons, or just nearly all kind of splines would work and provide the same function. A rectangular form would lead to uneven expansion of the gap between the protruding annular rim with an outwards rounded cross-section (18) and the congruent, fitting negative counter-form on the other main rotating part or system, when the rotary mechanism is changing its temperature during compression or expansion strokes.

### The Boundary Between the Female Rotor and the Other Parts

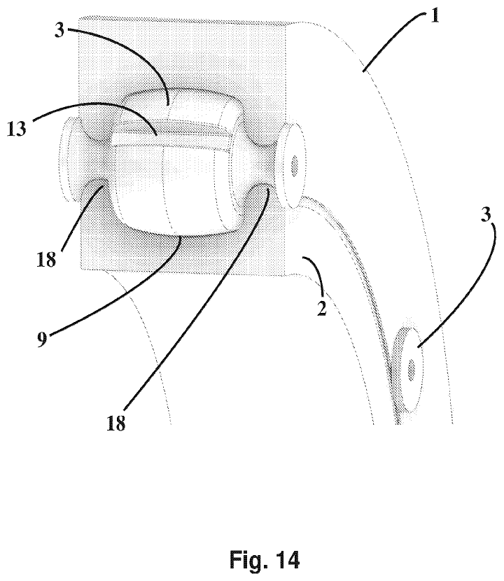

By extending, protruding with such a rounded annular rim radially outwards, radially beyond the outer radial boundary (8) of the annular space, the complementing counter-form of the female-rotor (3) has at this specific axial position—where the saddle-point of the protruding annular rim with an outwards rounded cross-section (18) is—a smaller diameter, than at other axial positions. This is shown in FIG. 14. This smaller diameter of the female-rotor (3) at the saddle-point (18) of the protruding annular rim with an outwards rounded cross-section (18) leads in turn to a smaller circumference of the female-rotor (3) at this specific axial position and thus to a smaller opening of the form-fitting recess (22) of the main rotating part or system, in which the female-rotor is embedded, at the saddle-point (18), thus the gap at the position, where the three parts or systems—the male-rotor (2), the female-rotor (3), and the part or system (1), in which the female-rotor is embedded—are coming together, is kept significantly smaller, as it would be without this special shape. (In FIG. 14 this is where the female-rotor (3) has its smallest diameter.)FIG. 14 also shows that the form-fitting recess (13) in the female rotor (3) which is necessary to let the fixed feature or part on the other main rotating part—in our exemplary embodiment the rotor (2)—pass through the female-rotor (3) is just a groove running all the axial length of the wider middle section of the female rotor (3) and thus also easy to adjust to the counter-part, the other main rotating part—in our exemplary embodiment the rotor (2). Otherwise it would be necessary to adjust the form-fitting recess (13) of the female-rotor (3) also axially to the counter-part with a minimal gap, which is changing temperatures during operation of the compressor, expander, or pump and thus a difficult task.

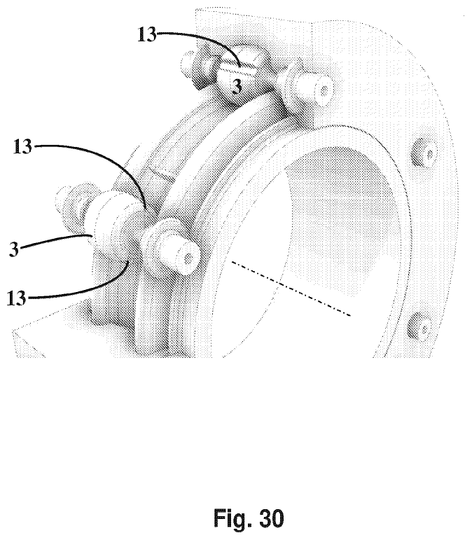

While in this example of FIG. 14 the female-rotor (3) displays only one single form-fitting recess (13), it is also possible to have more than one form-fitting recess (13) in the female-rotor (3), as can be seen in FIG. 30, in which case the female-rotor (3) would consequently have a different rotational-speed.

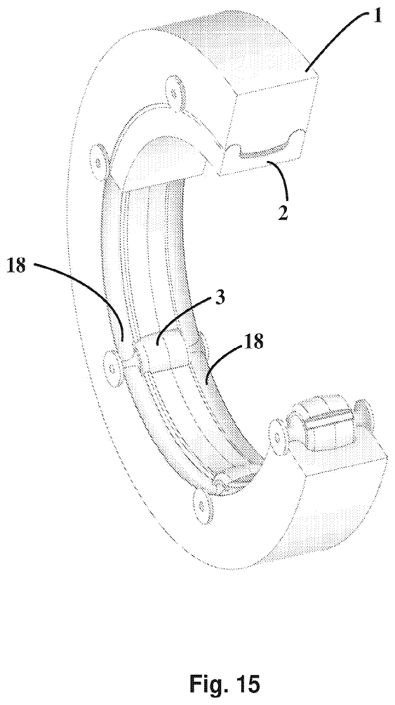

FIG. 15 shows the same as FIG. 14, however from a different view-point, with a part of the inner part of the rotating parts or systems—in our exemplary embodiment the rotor (2)—partly cut away to allow a free view to where and how a female rotor (3) is embedded in the outer part—in our exemplary embodiment the stator (1). The different view of FIG. 15 reveals the reduced length of the gap—caused by the form-fitting recess for the female-rotor (3)—in the outer part of the two main rotating parts or systems—in our exemplary embodiment the stator (1).

FIG. 15 also shows that the congruent, fitting negative counter-form of the protruding annular rims with an outwards rounded cross-section (18) of the outer part of the two main rotating parts or systems—in our exemplary embodiment the stator (1)—is interrupted by each form-fitting recess for the female-rotor (3).

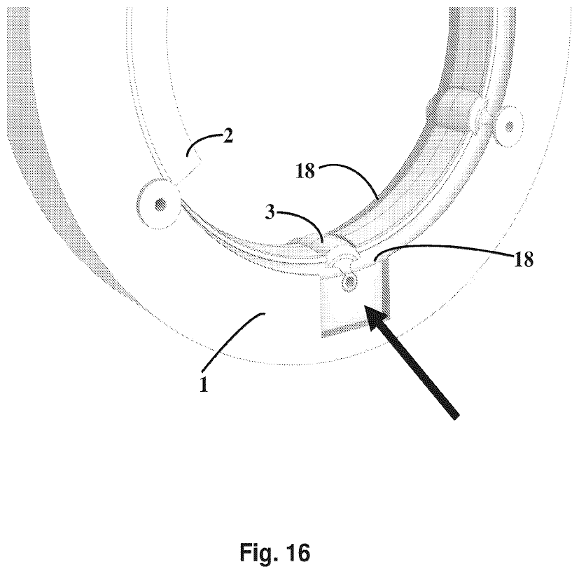

FIG. 16 shows with a partial cut—a black arrow points to this partial cut—the location, where the female-rotor (3) and the main rotating part or system (1), in which the female-rotor (3) is embedded—in our exemplary embodiment the stator (1)—are interrupting the otherwise uninterrupted closed surface of the congruent, fitting negative counter form, thus revealing clearly the gap in this surface. As in all the other Figures, also in FIG. 16 this gap is shown wider, as it would be or could be in reality, as it is easier to be seen in a drawing, than a gap with a width smaller than 0.1 mm.

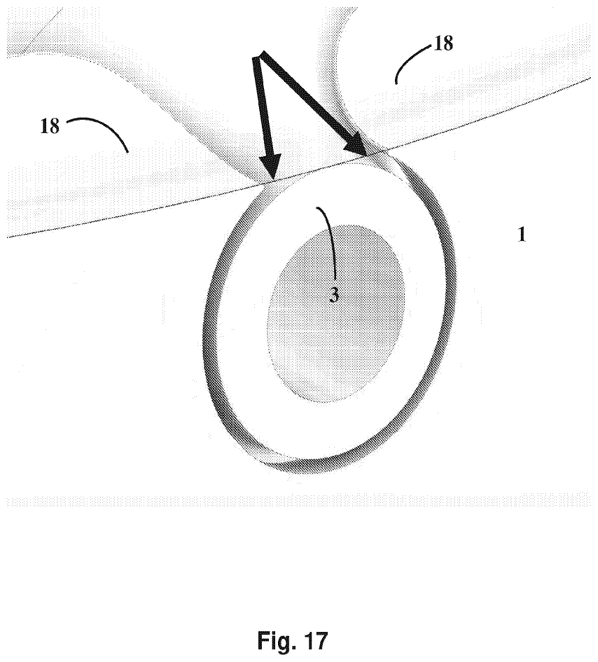

In FIG. 17 the exact same, as in FIG. 16 is shown in a closer and thus enlarged view as in FIG. 16 with two arrows pointing to the gap, caused by the radius on the edge of the congruent, fitting negative counter-form of the protruding annular rim with an outwards rounded cross-section (18) and the round shape of the female-rotor (3). An additional curve at the tip of the arrows shows where the edge would be without the interruption, caused by each form-fitting recess for the female rotor (3).

Thus it is revealed the congruent, fitting negative counter-form of the protruding annular rim with an outwards rounded cross-section (18) cannot seal completely, as it would be the case, if there were no interruptions by the form-fitting recesses (22) of the female-rotors.

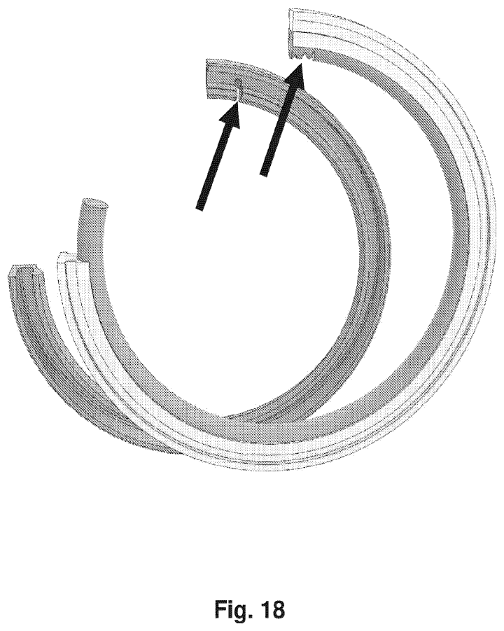

FIG. 18 shows two different conventional rotary sealings—the darker conventional rotary sealing in the background is an ISO standard part (ISO 6194/1 Type 1)—as examples, as they are used millions of times in various applications nowadays. Both shown examples have an added damage in form of a small easily visible gap in the circumference, which is not supposed to be in such a rotary-sealing—two arrows are pointing to these visible gaps. With these small visible gaps—that could be damages in real life—these rotary sealings cannot function any more as they are supposed. This is a well-known fact for (mechanics) the person skilled in the arts.

An even greater gap—in comparison to the shown gap in FIG. 18—or interruption of the otherwise continuously closed congruent, fitting negative counter-form of the protruding annular rim with an outwards rounded cross-section (18), which is caused by the form-fitting recess (22) for each female-rotor, is having the same effect and thus significantly minimises to completely prevents the ability to seal the annular space or annular chamber in the same way, than an un-interrupted surface.

The Boundary of the Annular Chamber with the Fixed Feature or Part (5)

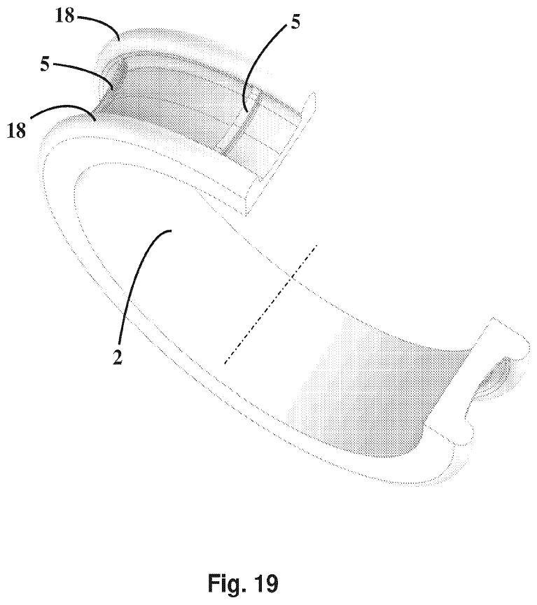

The at least one fixed feature or part (5) is in our exemplary embodiment mounted on, or part of the inner main rotating part—the rotor (2). It acts as a barrier of an annular chamber and is defined by the other boundaries of the annular space. Together with the two axial boundaries of the annular space and thus of the annular chamber with the protruding annular rim with an outwards rounded cross-section (18)—on both axial sides—the fixed features or parts (5) form pockets between two of the fixed features or parts (5). This can be seen in FIG. 19.

### Avoiding Sharp Angles at Edges

With this protruding annular rim with an outwards rounded cross-section the edge where all three rotating systems are overlapping has an angle, which is not sharp, and can thus easily be fit with a radius without causing a high increase of leakage losses, as it would be the case at this specific location with a sharp angle. This can be seen in FIGS. 14 to 17—especially at the enlarged view of FIG. 17.

In the different used Figures the gaps are shown much wider, than they would be or could be in reality, in order to see them better.

### Generating and Using Centrifugal Forces for Sealing Purposes

When such a rotary mechanism is working—either as a compressor, an expander, or a pump—centrifugal forces are generated. The fluids, which are in the annular chamber, will be subject to the relative rotation and thus also centrifugal forces will apply to these fluids. These centrifugal forces will force heavier parts, particles and especially droplets or mist outwards—away from the centre of the rotational movement.

In case a gas is compressed with such a rotary mechanism, there will also be droplets, which are formed during the suction of the gas, when the suction leads to a pressure drop—without this generated pressure drop the gas could physically not flow into the annular chamber—and this pressure drop in turn leads to the sucked-in gas passing below the specific thaw-point of the sucked-in gas, thus some mist or droplets are forming.

The outermost feature is the outwards protruding annular rim with an outwards rounded cross-section. There between the saddle-points (18) of this outwards protruding annular rim with an outwards rounded cross-section and the congruent, fitting negative counter-form droplets, mist, and heavier particles will accumulate and generate a film, which is used for sealing purposes, which is explained in more details below, as this is only possible together with other features and functions.

### The Primary, Interrupted Sealing Feature

This protruding annular rim with an outwards rounded cross-section of the two main rotating parts or systems functions together with the congruent, fitting negative counter-form as the primary, interrupted sealing feature of the annular space and thus also of the annular chamber.

The gap between the two main rotating parts or systems—the stator (1) and the male-rotor (2)—is not a closed gap between two rotating parts, but interrupted, at each location where a female-rotor (3) is embedded.

While one of the two main rotating parts or systems—in our exemplary embodiment the inner part or system, which functions as male-rotor (2)—has an uninterrupted outer surface around its circumference, specifically at the protruding annular rim (18) with an outwards rounded cross-section, which functions as axial boundary—as can be seen in several of the Figures, especially in FIG. 19—the other main rotating part or system, in which the female-rotor is embedded has an interrupted surface—as can be seen in several of the Figures, especially in FIGS. 15 and 16—and has and needs a gap at the specific locations where the female-rotor are embedded and rotating in form-fitting recesses (22). Through this gap or gaps leakage of fluids can and will occur. The gap between the two main rotating parts or systems is in fluid communication with the gap around the female-rotor. Fluids—gases and liquids—can exchange from the gap between the two main rotating parts or systems to each gap around a female rotor (3).

These leaking fluids will additionally flow through the gap axially outwards, away from the annular chamber.

### The Secondary, Un-Interrupted Sealing Feature

The secondary, uninterrupted sealing feature is realised with the axially-outwards continuation of the gap between the two main rotating parts or systems—the stator (1) and the male-rotor (2).

In the same way, as between the two main rotating parts, there is also an added axially-outwards continuation and thus another secondary, uninterrupted sealing feature of the gap between the female-rotor (3) and the main rotating part in which the female rotor (3) is embedded—in our exemplary embodiment the stator (1).

### Forming the Special Continuations of the Interrupted Gaps

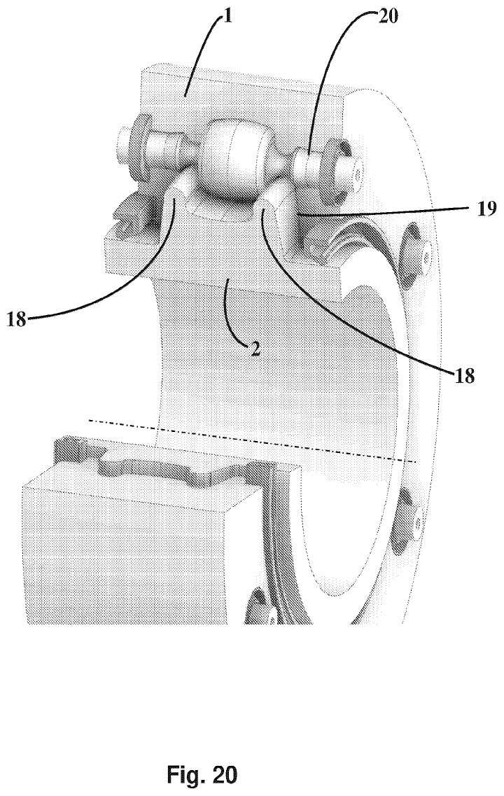

FIG. 20 shows, how the necessary gap between the inner rotating part or system—here the rotor (2)—and the outer rotating part or system—here the stator (1)—continues beyond the protruding annular rim with an outwards rounded cross-section (18), axially outwards, further away from the annular chamber. There, the path of this necessary gap between the main rotating parts is turning or bending—when looking at the partial cut of FIG. 20—towards the centre-line (in FIG. 20 this is downward) of the main rotating parts. In FIG. 20 the continuation of the gap (19) is bending from the circular form of the protruding annular rim with an outwards rounded cross-section in (in this specific example) with an angle of 81 degree downwards, towards the centre-line of the main rotating parts or systems. Also, other angles are possible.

### The Two Main Functions of the Bending-Angle

This angle is chosen as it reflects and represents the relation between the axial and radial dimensions of the rotary-mechanism—in this exemplary embodiment the mathematical relation between the axial and the radial length is 1 to 6.314 (one axial length to six-point-three-one-four radial length). Thus the thermal expansion of the parts will lead to no or at least no significant change of the width of the gap between the main rotating parts when this rotary mechanism changes its temperature, as the total axial-expansion of the parts reaches only about a sixth of the total radial-expansion of the parts or systems—the same axial-to-radial-ratio or relation as the angle of 81 degrees.

In other embodiments the ratio of axial-to-radial dimensions might be different and hence a different angle would reflect and represent the axial-to-radial ratio or relation of thermal expansion, leading then as a consequence to a different angle, than 81 degrees.

Some different angles might be chosen, for example for different axial to radial dimensions of the rotary-system, which could be in the range from 1 degree to 89 degrees.

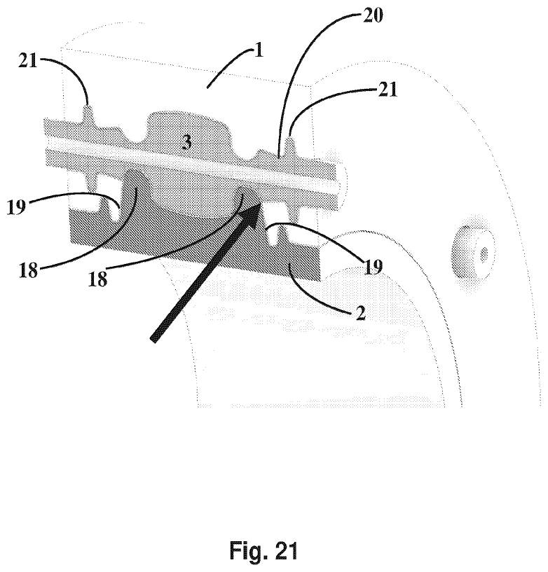

The angle of the continuation itself is not arbitrary, but has two functions:
the angle leads to a gap that expands evenly with the thermal expansion of the parts, hence keeps the same distance or clearance and—provides with a large bending-angle sufficient space for the similar features of the female-rotor (3); such possible features are shown in FIG. 21, which is a cut through the centre of a female-rotor (3) and shows additional features like additional saddle-points (21)—which will be explained later—as part of the un-interrupted continuations (20) of the gaps.
   Splitting the Uninterrupted Gap into Two Separate Gaps

FIG. 21 shows a similar partial cut as FIG. 20, but completely through the centre of a female-rotor (3). Also the three different parts or systems are shown in different tones—the male-rotor (2) in dark grey, the female-rotor (3) in light grey and the stator (1) in nearly-white grey. The split of the gap—with the tip of an arrow pointing to the splitting-edge—is thus easy to recognise. These gaps go around the respective rotors, thus these gaps are three dimensional and are only in the two-dimensional drawing of FIGS. 21 shown, and thus visible as a line.

In FIG. 21 one of the two uninterrupted gaps (20) follows the form of the female rotor (3) and the other uninterrupted gap (19) follows the form of the male-rotor (2).

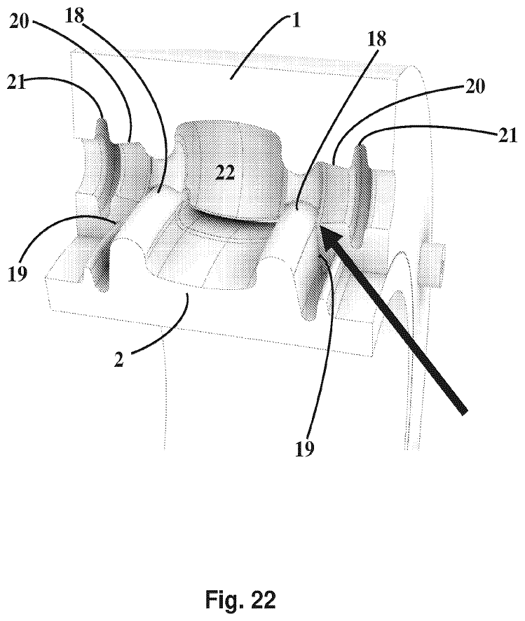

Also FIG. 22 shows, how the continuation of the gap—between the main rotating parts or systems and the female-rotor—splits at the axially outer side of the protruding annular rim with an outwards rounded cross-section (18) into two different gaps, one gap (19) continuing between the two main rotating parts or systems, the other gap (20) continuing with the contour of the female-rotor (3). Also in FIG. 22 a black arrow points with its tip to the location, of the split of the gap on the right side—as can be seen there are two axial sides.

What can also be seen in both FIG. 21 and FIG. 22: the split of the gap into two different uninterrupted gaps has an angle of 90 degrees to the shown bending-angle of 81 degree, resulting from the chosen said 9 degrees angle—which is not a sharp angle and will thus not unnecessarily increase the gap with a necessary minimum radius.

Instead of a 90 degree angle between the two separate continuations of the gaps after they are split, also angles in the range from 45 degree to 135 degree would be possible, however they would not be as advantageous as a 90 degree angle, as only a 90 degree angle avoids sharp angles on each possible side.

### Clearing Space for the Additional Sealing Features of the Female-Rotor

Instead of continuing the gap between the two main rotating parts or systems parallel to their main centre-line, the continuations of the gap (19) bend away from the form-fitting recess for the female rotor (3), thus forming in its continuations an uninterrupted part of the gap (19) between the two main rotating parts or systems. By sufficiently bending away from a theoretically parallel continuation of the gap, the bent continuation of the gap (19) between the two main rotating parts or systems, leaves also enough space for the continuation of the gap of the female-rotor to form an additional uninterrupted part of the gap (20) with a feature with a larger diameter for an additional saddle-point (21) on the female-rotor (3).

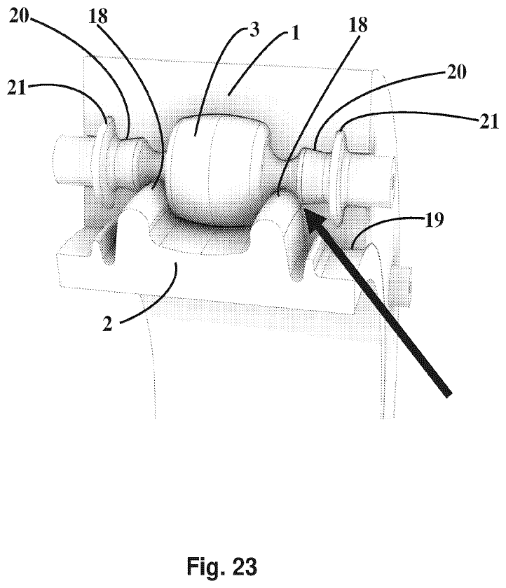

This is then shown in FIG. 23 slightly different with a visible complete female-rotor (3) on the male-rotor (2) with the stator cut along the centre-line of the female-rotor (3). Also in FIG. 23 an arrow is pointing to the very spot, where the connected gaps of the two main rotating parts or systems and the female-rotor (3) are separating and forming different continuations of the gap, which are, from this point outwards, independent—the gap (19) of the two main rotating parts or systems (19) is independent from the gap (20) around the female-rotor with its own feature with an additional saddle-point (21).

With the continuation of the gap between the two main rotating parts or systems bending away from the continuation of the gap of the female rotor (3), the fluid communication between both gaps—the gap between the main rotating parts or systems and the gap around the female rotor (3)—are disconnected. The forming and establishing of the independent and un-interrupted gaps is enabled through the bending of the separate different continuations.

### The Backing-Up Function of the Additional Saddle-Points

Using a hyperboloid-of-rotation-like shape for either each, or at least one of those continuations of the gaps (19 or 20) with an additional protruding feature with an increasing radius—as can be seen in FIGS. 21 to 23—thus with an additional saddle-point—adds an additional annular space where mist and droplets will accumulate. FIGS. 21 to 23 show this additional saddle or saddle-points of the secondary, uninterrupted sealing feature for both—the continuation of the gap of the two main rotating parts or systems and in FIGS. 21 to 23 also for the continuation of the gap around the female-rotor with its own feature with its saddle-point (21).

As this additional saddle-point is integrated in the uninterrupted part of the necessary gap, this saddle-point would also accumulate droplets and mist but keep them, different to the interrupted gap, at each saddle-point, as there are no interruptions of this annular feature, where droplets and mist could leave this annular space, as the centrifugal forces also keep them in place. Thus this additional saddle-point functions as a barrier, in turn significantly increasing the sealing effect between the rotating systems—male-rotor (2) and stator (1), as well female-rotor (3) and form-fitting recess (22), in which the female-rotor is embedded. Mist and droplets, which would form a film at the saddle-point (18) of the protruding annular rim with an outwards rounded cross-section can escape this first interrupted annular gap—as described above—but they are then stopped in their path and consequently backed-up by the second saddle-point—either of the saddle-point of the two main rotating parts or systems or the saddle-point (21) of the female-rotor (3)—and thus cannot continue to generate continuous leakages.

Centrifugal forces press at the saddle-point the accumulated droplets and mist outwards, away from the centre-line of the rotation. Any leaking gases need first to overcome the centrifugal forces at the saddle-point and move the droplets and mist against the centrifugal forces away from the saddle-point, in order to pass the saddle-point. By choosing the right parameters of the width of the gap, the radius of the saddle-point, in connection with the rotational speed of the rotating part, the mist and droplets at the saddle-point can form an effective liquid physical barrier. The former German industrial standard DIN defines in DIN 7157 gaps and their width in order to allow functionality, for example to enable a shaft to easily rotate in a hole or recess. DIN 7157 has and still is gradually replaced by ISO 286. Both standards give recommendations for gaps of rotating systems taking into consideration the change of the gaps with the in- or decrease of the size, and the possible accuracy of production. For a male-rotor diameter of 200 mm for a system, as has been described above, a width of a gap between 5 μm to 200 μm would be best suitable.

### Additional Sealing Functions of the Uninterrupted Extensions of the Gap

### The Length of the Gap Itself

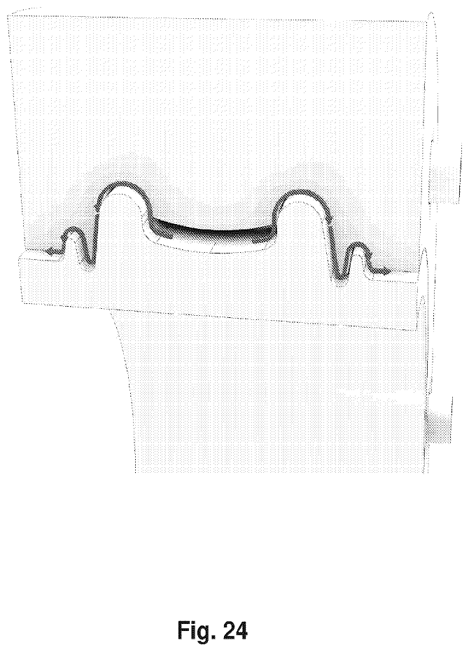

Additional to the effects provided by the shape of these extensions themselves, also the length of each of these continuation of the necessary gaps (19 or 20) plays an important role: if and when there is higher pressure inside the annular chamber, than at the exit of the necessary gaps of the two main rotating parts and at the exit of the female rotor (3), then fluids will start to travel through the gap (either 19 or 20) or gaps (19 and 20) towards the area with lower pressure, hence towards the exits of the necessary gaps—this travel of fluids is shown with dark-grey arrows symbolising the path of such leaking fluids in FIG. 24.

If the geometry of these gaps is made in a way that each continuation of the gap takes for the traveling fluids more time, in order to reach the exit of the gap (19 or 20), beyond the secondary, uninterrupted sealing feature, than it takes the rotating mechanism to switch or change from higher pressure to a lower pressure in the annular chamber (7)—from a compression-stroke to a suction-stroke or from expansion from high pressure to low pressure of the completed expansion or even condensation at the end of expansion—then the fluids will reverse their direction in the gaps and travel backwards in the gaps, backwards towards the annular chamber—the annular chamber now with lower pressure—before they can leave the system. In this way leaking is additionally prevented.

The factors, which have the largest influences on the speed of the fluids in the gaps (either 19 or 20, or 19 and 20) are the overall size and shapes of the system thus also the minimum and maximum dimensions of the gaps, the precision of the parts, the surface-structure of the parts, added surface-structures, eventually coating of the surfaces of the parts forming the boundaries of the gap or gaps, the necessary gap-width to allow free rotation of the rotors (2 and 3) also taking differences in the temperatures into consideration, the temperature of the system, the temperature of the fluid or mixture of fluids themselves, the viscosity of the fluid or fluids, the composition of the fluid or fluids, the reached pressure, the pressure difference between the annular-chambers and the outside, the chosen sealing-method or sealing for the ends of the uninterrupted gaps (19 and 20), additionally the reached rotational speeds thus the resulting centrifugal forces. The number of possible combinations and thus the number of different possible speeds of fluids in a gap (19 or 20) or the gaps (19 and 20) can thus vary widely.

The constant change between higher pressure and lower pressure in the annular chambers of such rotary-mechanism—when used as compressor or expander—can be used together with the specific geometry of the gap to reach highly effective, additional sealing-effects. Often compressors are encapsulated. In split-air-condition-systems, as an example, this is usual. In such a case the pressure in the encapsulation can be chosen to be slightly above the lowest pressure in the annular-chamber of the rotary-mechanism. Thus, such a compressor could not leak, because the outside pressure—outside the compressor, inside the encapsulation—would be higher, than the lowest pressure in the compression-chamber—the annular chamber (7) and it were possible to design the length of the uninterrupted continuation of the gap in a way that neither fluids can escape nor enter the system, but instead would permanently change direction, thus oscillate, inside the gaps and thus lead to a quasi-stabile situation without leakage.

### Designed Pressure Drop at the Saddle-Point

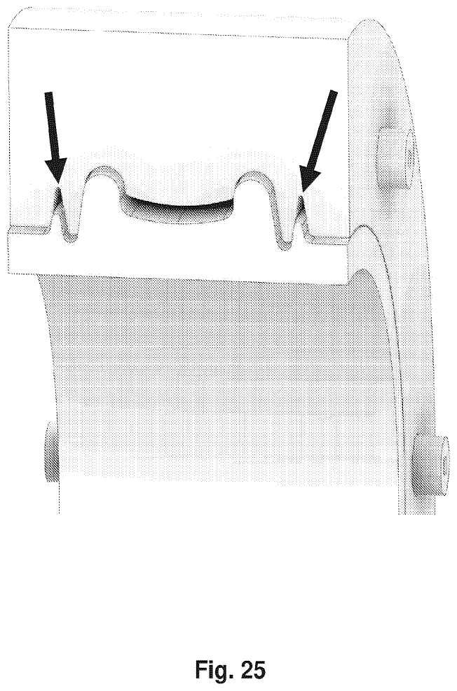

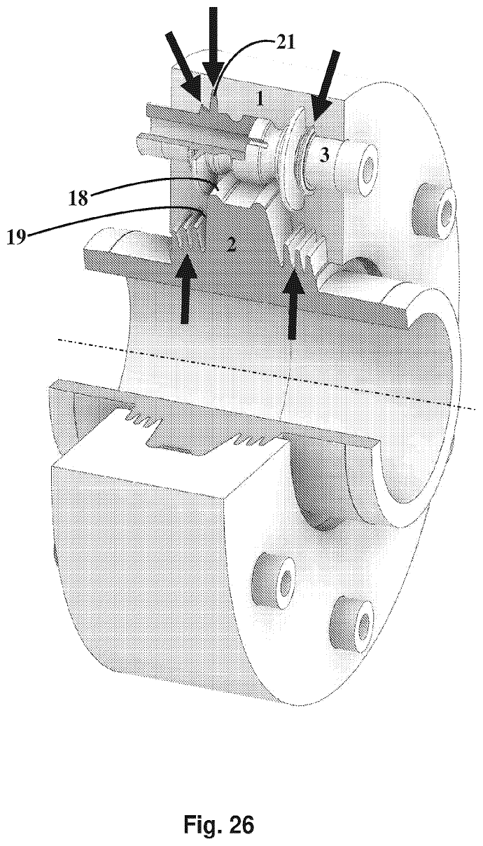

It is also possible to additionally enlarge the cross-section and thus increase the volume of the gap directly at a saddle-point of the hyperboloid-of-rotation-like shape of the secondary, uninterrupted sealing feature and cause here the effect of lowering the pressure as described above, as this is shown in FIG. 25 with two arrows pointing to the saddle-points with enlarged cross-section and thus increased volumes. The volumes could be, solely as an example, large enough to have several times the width of the gap over the same axial distance.

### Varying the Width of the Gap

By dynamically varying the width of the continuation of the gaps between any of two rotating parts or systems the pressure of the leaking fluids would also vary, as the pressure is indirectly proportional to the volume, which the leaking fluid can occupy in the gap. By increasing the gap and thus lowering the pressure, the flow of fluids can be slowed down to the point that no fluids are leaking at the end of the gap, due to lowering the pressure below the pressure outside the gap thus cancelling the effect of the pressure difference of the pressure outside and within the gap, thus preventing a flow of fluids and thus leaking.

Varying the width of the gap can especially be used in a way, where towards a saddle point the gap is slowly increasing and after the saddle point the gap is significantly smaller. There is then no energy in the leaking fluids left to keep the same pressure and speed the fluids had, before reaching the saddle point, thus they slow significantly down.

By combining this effect with several succeeding saddle-points, as shown in FIG. 26,—with black arrows pointing to the additional saddle-points, the leaking fluids can be stopped from escaping the system, at least leakage can be significantly minimised.

### Surface Structure

It is also possible to add structural features on surfaces in the small gap between the rotating parts or systems beyond the protruding annular rim with an outwards rounded cross-section, thus in the continuations of the gaps. Such surface structures can cause fluid-mechanical effects, which lead to more friction of the passing fluids and thus, in turn, slow down the stream and in turn the pressure of fluids in the gap. Such features can additionally prevent or significantly minimise leakage losses.

Thus, effects of added structural surface features are known and used for example in cylinders of combustion engines, where cross-honed surfaces on the inner side of the cylinders slow the flow of the used lubricants (engine-oil) downward and thus increase the blocking effect of those lubricants.

### Use of the Saddle-Points and the Additional Sealing Features

The additional saddle-points and the said three additional sealing-features—the length of the path, the variation of the width between the rotating parts or systems, and the surface structure of the gap—together complement each other. However, it is also possible to use only some of these sealing features—for example for reasons of lower production-costs, or because the occurring pressures are low enough, to reach sufficient sealing without using all these mentioned and described additional sealing features.

Also the opposite is possible, and more than one of each described additional sealing feature can be used, for example several saddle-points with paraboloid-like shapes with different sizes in a row, similar to a labyrinth-sealing—as shown in FIG. 26.

In FIG. 26 the continuation of the gap (19) beyond the protruding annular rim with an outwards rounded cross-section (18) has between the rotor (2) and the stator (1) three features each with an additional saddle-point on each axial side—with an arrow pointing to it from the middle—while the female-rotor (3) has one large protruding saddle and three additional smaller saddle-points on each axial side following axially outwards—also here arrows point to it from the top.

### No Restriction on the Geometrical Form of the Second Saddle Points

For this described function of a saddle point it is not necessary to follow strictly the geometrical form of a hyperboloid-of-rotation form—also straight walls and simple round forms can provide the same effects. For that reason, the term hyperboloid-of-rotation-like—with the term “like” in it—was chosen.

### No Restriction on the Geometrical Form of the Continuation of the Gaps

In FIGS. 20 to 22 each of the continuations of the gaps (19 and 20) between the different rotating parts is shown as fairly straight connections—in the cross-section visible as straight lines—between the radiuses/radii of the saddle-points and turning points, which leads to parts and systems that can be produced or manufactured in an easier way, than complicated forms, like a continuation of the gaps in not straight but polygonal, splines, or other non-straight forms. For the basic function—to form an uninterrupted part of the continuation of the gaps between the rotating parts—the geometrical form of the gap itself is not important and has no influence on the described specific functions.

While the paraboloid-of-rotation-like shape has the advantage that the angle of its arms (the part of the form that is on both sides of the rounded saddle-point) can be used to balance the differences of axial and radial thermal expansion of the parts and thus have over a large range of temperatures a constant distance in the gaps between the different rotating parts—as it is the base of and described in U.S. Pat. No. 4,890,990—Zettner (WO1987002096A1) -also other forms are possible. If—just as an example—the mechanism is used as a pump for a liquid, and or the thermal expansion is not considered significant, then other shapes or altered shapes for the secondary, uninterrupted sealing features might as well be used, like straight walls instead of arms of a paraboloid-like form, rectangular saddles instead of rounded saddles with a clear saddle-point, etc.

### Inverse Configuration of Stator and Rotor

In our exemplary embodiment the rotor (2) is the inner part of the two main rotating parts or systems and the female rotors (3) are in form-fitting recesses in the outer part, which is in our exemplary embodiment the stator (1). Thus the extension of the gap between the two main rotating parts or systems needs to bend towards the centre line of the two main rotating parts or systems in order to form an un-interrupted gap between the two main rotating parts or systems and provide the required space.

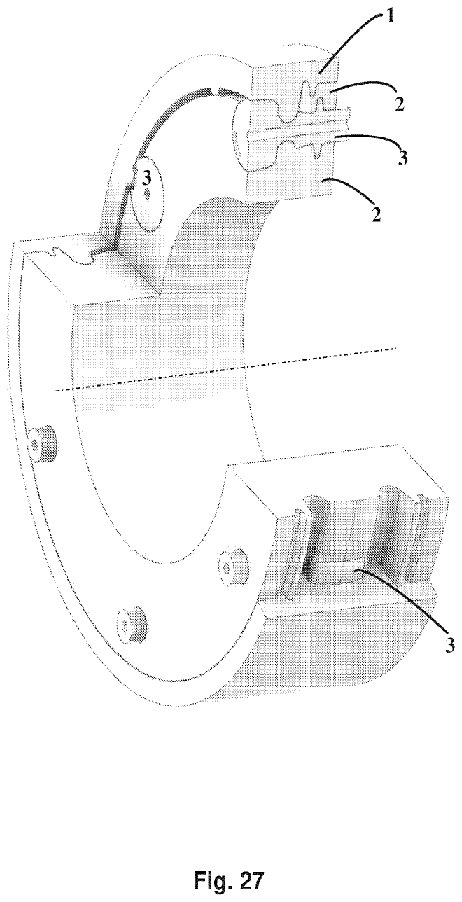

In case the female rotors (3) were embedded in the inner of the two main rotating parts or systems, then this gap between the two main rotating parts or systems had to bend outwards, away from the centre line of the two main rotating parts or systems—as it can be seen in FIG. 27.

Possible Combinations with Other Features

As it is possible to either add or leave out certain features, it is also possible to add or integrate additional, sealing-related and not sealing-related features to the existing, sealing-related features. As two examples:

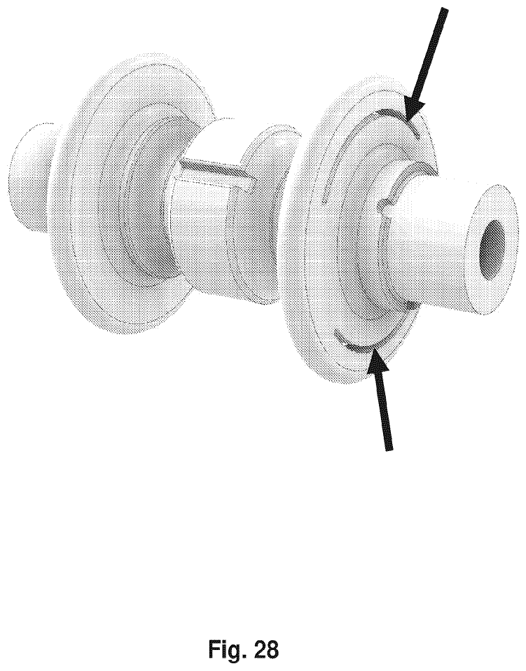

Additional openings in the paraboloid-of-rotation-like feature that can function as rotary-slide-valve, not connected to the sealing-functions. FIG. 28 shows a female rotor (3) with such openings in the paraboloid-of-rotation-like form in the secondary, uninterrupted sealing features, which is used as a rotary-slide-valve.

An opening for injection of an additional lubricant or liquid at the saddle-point of the paraboloid-of-rotation-like shape would be an example for a sealing-related additional feature.

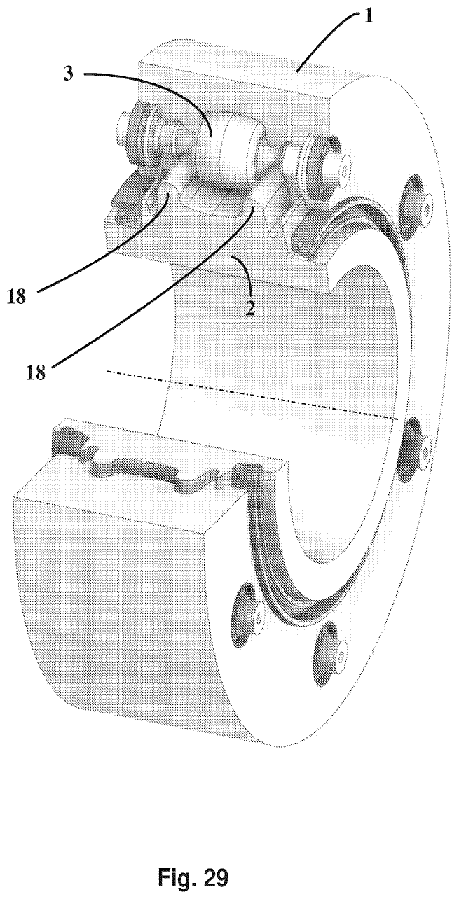

Adding a conventional rotary sealing at the end of the axial extension axially after the second, uninterrupted sealing feature would also be another exemplary embodiment for a sealing-related additional feature—this can be seen in FIG. 29.

Possible Combination with Anti-Friction- or Ball-Bearings

It is also possible to combine this new sealing system with anti-friction-bearings like precision-ball-bearings, conventional ball-bearings, magnetic-bearings and similar bearings. Capsulated ball-bearings and capsulated precision-ball-bearings would also—with their capsulation—provide an additional sealing, similar to a rotary sealing. The bearings could be used for precise mounting of the different rotors in the system, by adding these bearings for example at the end of the shafts of the rotors, similar to the position of the standard rotary sealings in FIG. 20.

### Mirroring Both Sides

Choosing a symmetric design, where the shapes are mirrored at the mid-plane, this mid-plane standing perpendicularly on the centre-line of the main rotating parts, leads to mirrored and thus balanced forces on axial surfaces. While a mirrored design is the most usual and mostly used form, for the function of the sealing features this symmetry is not required and this sealing could also be asymmetric and or different on each axial side.

### Exemplary Embodiment where all Those Features are Realised

In FIG. 26 an embodiment of such a rotary mechanism is shown, where all those features described above are realised. This could be used as a compressor and also as an expander, whereby the direction of the rotation would be opposite.

### Exemplary Embodiment with Only the Secondary, Uninterrupted Sealing Feature

In FIG. 20 an embodiment of such a rotary mechanism is shown, where only the primary interrupted sealing feature (at the axially outer end of the male-rotor-shaft after 19) and the secondary, uninterrupted sealing feature at the axially outer end of the female-rotor after 20) are realised. In this exemplary embodiment the gaps—after the secondary uninterrupted sealing feature are closed with conventional rotary sealings.

With the exemplary embodiment shown in FIG. 20 it becomes clearer, why the splitting of the interrupted primary sealing feature into two kind of uninterrupted sealing features—one for the two main rotating parts or systems (2) the other one for the female-rotors (3)—is from such important: it would otherwise not be possible to use any known rotary sealing for the interrupted primary sealing. There at the interrupted primary sealing the shafts of the female-rotors and the male-rotor are directly together, thus making it impossible to mount on both shaft-systems rotary sealings.

### Exemplary Embodiment with More than One Compression-Step

Compressors, which are built to reach higher compression-pressures have often more than one single step. In several cylinders—most common are two cylinders—which function in a series—one after the other—the pressure is succesivly increased.

For expanders this is also well known and established. The three-cylinder steam-engines of the “Liberty”-ships were, as an example, all equipped with three step-expanison-piston-steam-engines.

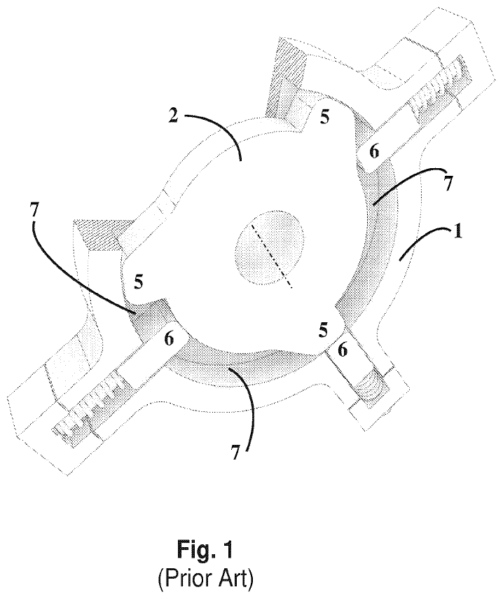

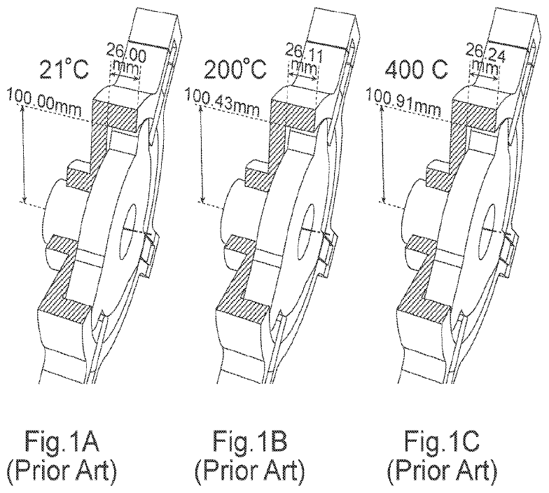

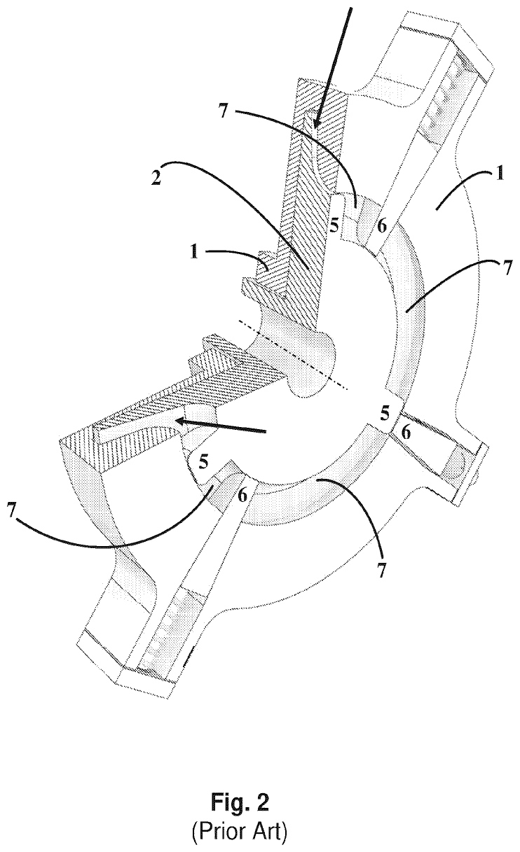

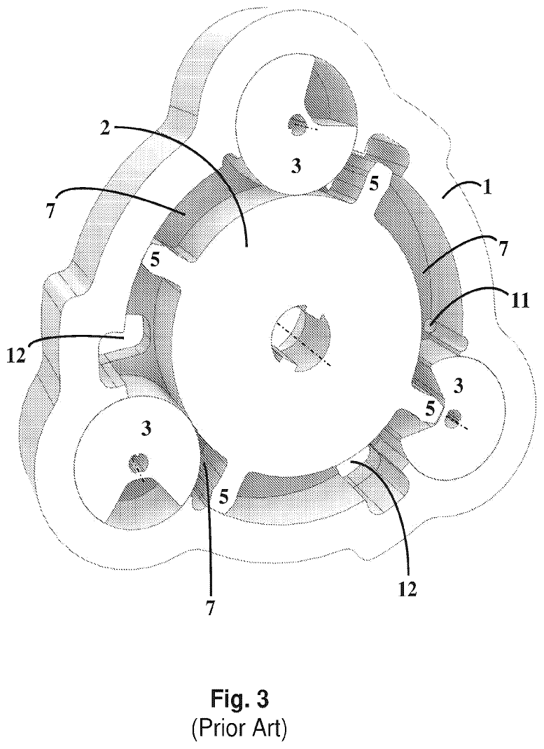

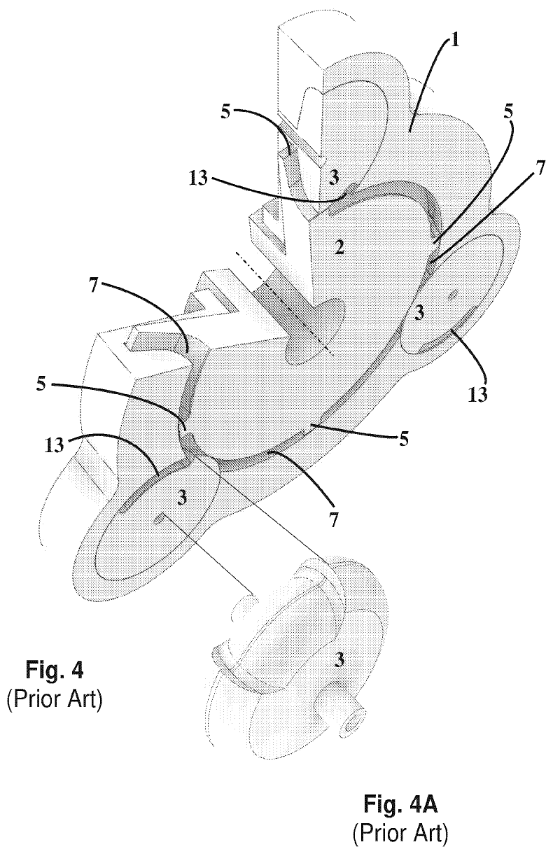

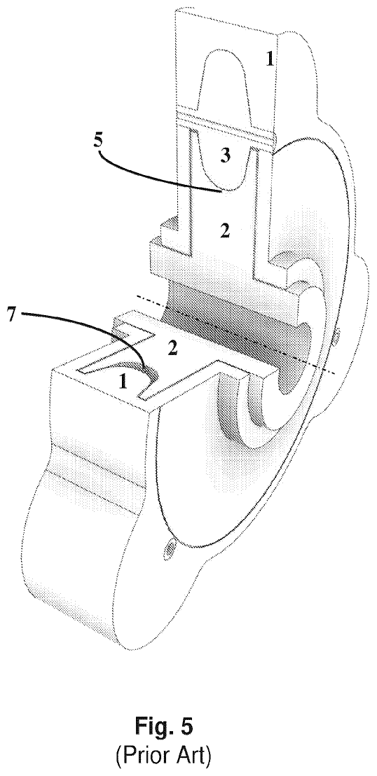

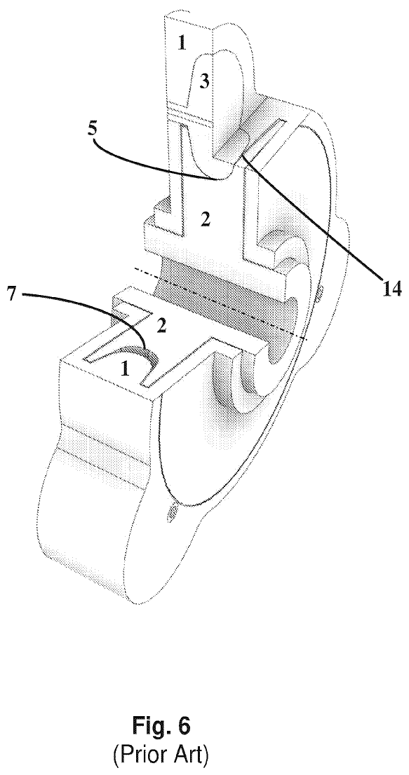

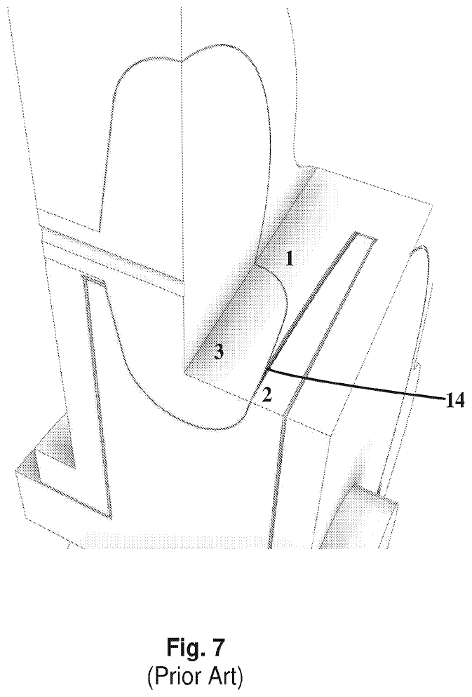

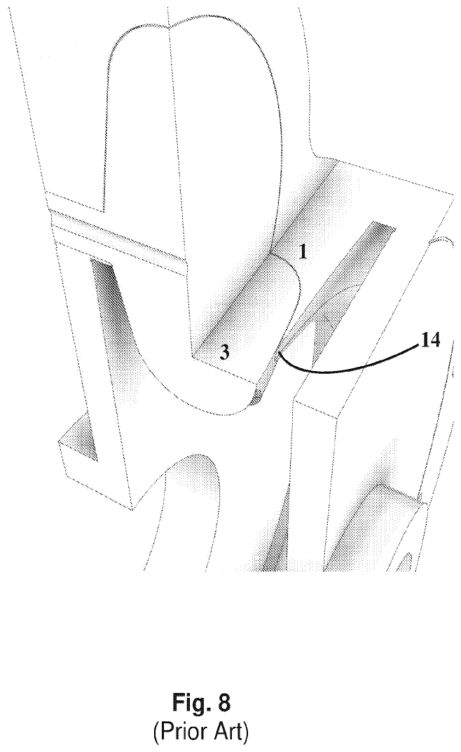

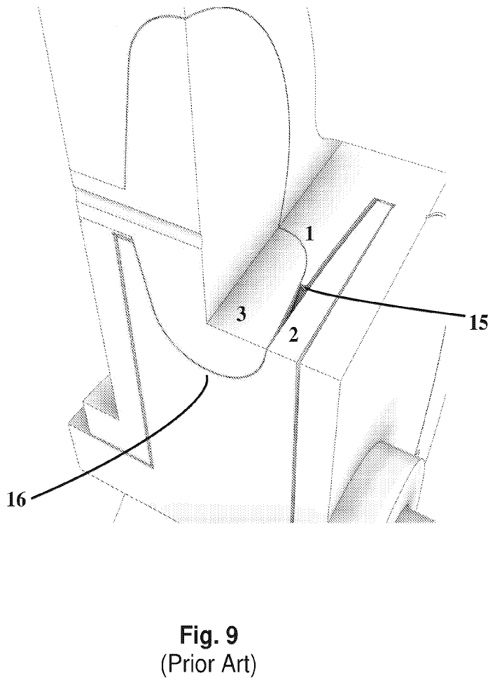

For rotary compressors or rotary expanders based on the invention it is also possible to have several steps and either increase the pressure of a compressor in several steps, or decrease the pressure of an expander in several steps, with either at least one of those steps to all of those used steps having the sealing-system described herein.

| FIG. 1 | Number | feature or part |
|---|---|---|
| | 1 | stator |
| | 2 | male rotor |
| | 3 | female rotor |
| | 4 | annular space |
| | 5 | fixed feature |
| | 6 | projected feature |
| | 7 | annular chamber |
| | 8 | outer radial boundary |
| | 9 | inner radial boundary |
| | 10 | axial boundary |
| | 11 | inlet opening |
| | 12 | outlet opening |
| | 13 | recess in female-rotor |
| | 14 | sharp angle |
| FIG. 8 | 15 | small radius 0.5 mm |
| FIG. 9 | 16 | saddle point FIG. 9 |
| FIG. 10 | 17 | annular space |
| FIG. 13 | 18 | saddle point of protruding round annular form |
| FIG. 20 | 19 | continuation of the gap |
| | 20 | uninterrupted part of the gap |
| FIGS. 21, 22 | 21 | saddle point of the female-rotor |
| | 22 | form-fitting recess for the female-rotor |

1-29. (canceled)

30. A rotary mechanism with a sealing system comprising: two main relatively rotating parts or systems configured to rotate relatively around a first axis common to said two main relatively rotating parts or systems, an inner of the two main rotating parts acting as stator and an outer of the two main rotating parts acting as the rotor, both main rotating parts confining an annular space between them, by complementing forms of the radial boundaries on both main rotating parts, the boundaries of said annular space, thus closing the annular space in axial and radial directions, except for a small annular gap between the two main rotating parts on each axial side, where the two main rotating parts enclose and confine said annular space in axial direction, said annular gap allowing both main rotating parts to freely rotate relatively to each other; at least one fixed part, protruding out of the main rotating part or systems, functioning as said stator and into said annular space enclosed by said two main rotating parts or systems, wherein said at least one stationary part forming at least one chamber with two circumferential borders in said annular space; and at least one additional rotating part or system, accommodated in a form-fitting recess within the other of said two main rotating parts or systems, functioning as said stator, said additional rotating part or system is configured to rotate within said form fitting recess around a second axis leaving an additional small, interrupted, partly annular gap between each of said at least one additional rotating part or system and each said form-fitting recess in the main rotating part or system, functioning as said stator, where the additional rotating part or system is accommodated, to allow each additional rotating part to freely rotate in said recess; wherein said small annular gaps between the two main rotating parts on each axial side allow both main rotating parts to freely rotate relatively to each other, and are interrupted by each said at least one additional rotating part or system and additionally by each small, partly annular gap between each of said at least one additional rotating part or system and each said form-fitting recess, thereby forming several connected, partially annular and thus interrupted gaps, with fluid communication of said annular space formed between the two main rotating parts through said several connected, partially annular and thus interrupted gaps to the outside; Characterized in that: radial continuation of said several connected, partially annular and thus interrupted gaps, either between the main rotating parts or systems, or between said at least one additional rotating part or system and said form-fitting recess, on both axial sides of said rotary-mechanism, is split axially away from said annular chamber between the two main rotating parts, and forming from each split away part a separated, uninterrupted, annular gap, one gap surrounding the main rotor and another surrounding said additional rotating parts or systems, the thus formed uninterrupted, annularly formed gaps can back-up leakage losses, leaking through said several connected, partially annular interrupted gaps from, or to, said annular chamber between said two main rotating parts or systems, and thus said uninterrupted, annularly formed gaps seal the rotary mechanism.

31. The rotary mechanism with a sealing system according to claim 30, wherein the axial limits of said annular space formed between said two main rotating parts or systems are on each of both axial sides a protruding, annular rim, as part of the inner main rotating part or system, extending radially farther outwards, than the radially outer boundary of said annular space, formed between the two main rotating parts or systems, with said form-fitting, complementing recess in the outer main rotating part or system for each of said two protruding, annular rims on said inner main rotating part or system, with said gaps between said protruding, annular rims and the form-fitting, complementing recess in the outer main rotating part or system, said gaps allowing both main rotating parts to freely rotate relatively to each other.

32. The rotary mechanism with a sealing system according to claim 31, wherein said splitting away is done by bending surface of said gap between edges of said inner and outer boundaries towards said first axis of said two main rotating parts or systems, and bending surface of said gap between said additional rotating part or system and the part or system where it is embedded away from said first axis of said two main rotating parts or systems.

33. The rotary mechanism with a sealing system according to claim 32, wherein angle of bending of said surface of said gap between edges of said inner and outer boundaries is 81°.

34. The rotary mechanism with a sealing system according to claim 31, wherein said rims and recesses have a rounded shape of their cross-section.

35. The rotary mechanism with a sealing system according to claim 30, wherein said at least one stationary part or system together with at least one said additional rotating part or system divides said annular space into at least two annular chambers with varying angular extensions, said annular chambers are configured to contain fluids either being compressed or expanding inside said annular space, and contract and expand said fluids inside said annular chambers upon rotation of said two main rotating parts relative each other.

36. The rotary mechanism with a sealing system according to claim 35, wherein each of said at least one additional rotating part or system comprises each at least one recess configured for coupling with said at least one stationary part upon rotation of said additional rotating part or system within said form fitting recess relative and simultaneously, thus synchronised, with said rotation of said two main rotating parts or systems relative each other, wherein said coupling allows each of said stationary part to pass through each of said at least one additional rotating parts.

37. The rotary mechanism with a sealing system according to claim 31, wherein said edges of said annular space enclosed by said two main rotating parts or systems increase radius of radial boundaries of said annular space with nearing axial edges of said annular space, wherein said increase of radius towards said edges increases relative rotational speed of sides of said chamber(s), wherein said increase of radius generates an axial force-vector in compressed, expanding or pumped fluids inside said annular chamber(s) towards said protruding annular rims, wherein said axial force vector causes droplets, mist, and/or heavier components to separate from lighter components and flow axially sideward towards said protruding annular rims, said droplets, mist and/or heavier components generate a film of droplets at the areas with largest radius.

38. The rotary mechanism with a sealing system according to claim 37, wherein said protruding, annular rims with an radially-outwards rounded cross-section are extending radially farther outwards, than the radial outer limit of said formed annular space, between said two main rotating parts or systems, thus allowing centrifugal forces at the radially outermost limits or edges of said protruding, annular rims the built-up of said droplets and or heavier components to generate a film of droplets, mist and or heavier components on the radially outermost limits or edges of said protruding, annular rims.

39. The rotary mechanism with a sealing system according to claim 31, wherein said gap between the two main rotating parts, and, connected to this gap, said gap between said at least one additional rotating part or system and the main rotating part, in which said at least one additional rotating part is accommodated, form together, with said split off continuations of said gaps, a path, through which a fluid communication between said annular chamber and the outer surrounding of said rotary mechanism can and will occur, said fluid communication through said path has a flow-speed whereby the specific axial extension and thus length of said path is increased by design of the parts in a way that the travelling time of said fluids with a specific flow-speed is longer along said path formed by said different gaps, than relative travelling time of said fluids in said annular chamber(s), said annular chamber(s) rotating with a selected angular speed, wherein said angular speed of said annular chamber(s) is either suitable for switching from a performance of a pressure-stroke with high pressure to a suction-stroke with low pressure, or from a performance of an expansion-stroke with high pressure to a complete expansion or a condensation-stroke in the said annular chamber(s), wherein said switching reverses pressure difference between said path and said annular chamber(s), wherein reversing said pressure difference causes leaking fluids flowing through said gap or gaps, to change their direction, and flow backwards, towards said annular chamber(s), wherein said change of direction and flow backwards prevents leaking of said fluids inside said gap out of said rotary mechanism.

40. The rotary mechanism with a sealing system according to claim 39, wherein at least one of split-away continuations of said gaps comprises at least one other protruding annular rim with an outwards rounded cross-section with a saddle-point, wherein said one other protruding annular rim is configured to accumulate and hold fluids by exerted centrifugal forces in said split-away continuation of said gaps, wherein said fluids and droplets and mist form a film at said saddle-point thus constituting a blocking sealing feature, said blocking sealing feature prevents leakage of fluids through said at least one split-away continuations of said gaps and backs-up leakages from said interrupted part of said gaps at said protruding annular rim with an outwards rounded cross-section through said split-away continuations of said gaps.

41. The rotary mechanism with a sealing system according to claim 40, wherein at least one of said split-away continuations of said gaps comprises a rotary-sealing at its end, said rotary-sealing constituting a blocking sealing feature, which prevents leakage of fluids through said at least one of said split-away continuations of said gaps and backs-up leakages from said interrupted part of said gap at said protruding annular rim with an outwards rounded cross section through said split-away continuations of said gaps, said rotary sealing is selected from a standard-rotary-sealing and or capsulated bearings.

42. The rotary mechanism with a sealing system according to claim 30, wherein said rotary-mechanism comprises at least two steps with similar forms and features, wherein said rotary mechanism is selected from a compressor and an expander.

43. The rotary mechanism with a sealing system according to claim 42, wherein said rotary mechanism is a compressor, wherein said compressor is configured to reach an increase of pressure in a first step of said at least two steps and a further increase of said pressure to a higher pressure in a second step of said at least two steps.

44. The rotary mechanism with a sealing system according to claim 42, wherein said rotary mechanism is an expander, wherein said expander is configured to reach a decrease of pressure in a first step of said at least two steps and a further decrease of said pressure to a lower pressure in a second step of said at least two steps.

45. The rotary mechanism with a sealing system according to claim 30, wherein said two main rotating parts or systems are a rotor and a stator.

46. The rotary mechanism with a sealing system according to claim 45, wherein said rotor is inner part or system of said two main rotating parts or systems and said stator is outer part or system of said two main parts or systems.

47. The rotary mechanism with a sealing system according to claim 30, wherein said at least one additional rotary part or system is a female-rotor.

48. The rotary mechanism with a sealing system according to claim 30, wherein said at least one additional rotary part is a female-rotor, wherein said female rotor is embedded in outer rotary part or system of said two main rotary parts or systems.

49. The rotary mechanism with a sealing system according to claim 30, wherein said rotary mechanism is inverted, wherein split-away continuations of gaps are bending outwards, away from said one axis of said two main rotary parts or systems and from said second axis of said at least one additional rotating part, said at least one additional rotating part is mounted on and integrated into inner of said two main rotating parts or systems, wherein sealing features of said sealing system are adjusted to said inverted rotary mechanism.
